(19) United States
(12) Patent Application Publication
(10) Pub. No.: US 2026/0318859 A1
(43) Pub. Date: Oct. 15, 2026

(54) NANOCOMPOSITE BIOSENSOR FOR PESTICIDE DETECTION

(71) Applicant: UNIVERSITY OF TABUK, Tabuk (SA)

(72) Inventors: Syed KHASIM, Tabuk (SA); Mohamed Rashad Shehata AHMED, Tabuk (SA); Shamselden Abderasoul Alzobair ISSA, Tabuk (SA); Panneerselvam Chellasamy VELLAISAMY, Tabuk (SA); Taymour Ahmed Hamdalla MOHAMMAD, Tabuk (SA)

(73) Assignee: UNIVERSITY OF TABUK, Tabuk (SA)

(21) Appl. No.: 19/177,368

(22) Filed: Apr. 11, 2025

(51) Int. Cl. G01N 27/30; B82Y 15/00; B82Y 40/00; G01N 27/327

(52) U.S. Cl. CPC G01N 27/308; G01N 27/3275; B82Y 15/00; B82Y 40/00

(57) ABSTRACT

A nanocomposite, a method of its preparation, and a method of detecting the presence of a pesticide in a sample. The nanocomposite includes 30 percent by weight (wt. %) to 65 wt. % titanium carbide nanosheets with alkylammonium ions disposed on the surface of the nanosheets, 30 wt. % to 65 wt. % nickel oxide nanoparticles, and 2 wt. % to 15 wt. % porous carbon-containing biochar, each based on the total weight of the nanocomposite.

### BACKGROUND

### Technical Field

The present disclosure is directed to a nanocomposite biosensor and a method of pesticide detection using the nanocomposite biosensor.

### Description of Related Art

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly nor impliedly admitted as prior art against the present invention.

The agriculture sector relies heavily on pesticides to ensure crop protection, enhance yield, and meet the growing global demand for food. However, the rapid growth of the agriculture sector has significantly contributed to biodiversity loss. Increased agricultural activity has led to a sharp increase in pesticide use globally over the past two decades. Prolonged and excessive use of fertilizers and pesticides has caused soil nutrient imbalances, acidification, compaction, salinization, and nitrate accumulation in crops, particularly vegetables, resulting in declining crop yields. In many cases, pesticides are employed as a defense mechanism without a comprehensive understanding of the long-term adverse effects of their use. Among the wide range of pesticides utilized, highly hazardous pesticides (HHPs) are of particular concern due to their potential to cause severe harm to human health, the environment, and biodiversity. A major drawback of pesticide use is the persistence of residues in food, posing health risks.

Consequently, the trace detection of pesticides has become a critical focus due to concerns over their presence in low concentrations within final food products and environmental contamination, particularly in water and soil. Therefore, detection hazardous pesticides at trace levels are essential to mitigate the dangerous adverse effects on human health and the environment. Traditional methods for pesticide detection include gas chromatography (GC), liquid chromatography (LC), and mass spectrometry (MS), which offer high sensitivity and accuracy but are often time-consuming, costly, and require specialized equipment. However, these methods face challenges such as expensive equipment, high technical complexity, time-consuming sample pretreatment processes (including separation and purification), elevated detection costs, and limited accessibility, which restrict their broader application and adoption. Recent advancements have introduced innovative techniques such as nanocomposite-based sensors, electrochemical detection methods, and biosensors, which provide rapid, cost-effective, and highly sensitive detection of pesticides at trace levels. These developments enable effective monitoring and management of pesticide residues, ensuring safety and compliance with regulatory standards, while promoting sustainable agricultural practices and mitigating environmental and health risks.

Recent advancements highlight the transformative potential of nanocomposites in agriculture. Nanocomposites high surface area and tunable properties have proven highly effective in detecting pesticide residues at trace levels. Beyond detection, nanocomposites also promote root growth by enhancing nutrient delivery, improving water retention, and enabling controlled release of growth stimulants. These innovations promote healthier, more resilient crops while addressing agricultural challenges. However, drawbacks persist. Nanocomposite synthesis can be costly and complex, with potential environmental and health risks due to nanomaterial accumulation in ecosystems.

Accordingly, one object of the present disclosure is to provide a nanocomposite, and method of pesticide detection thereof, that may circumvent the drawbacks and limitations, such as the high cost, time-consuming processes, complex sample preparation, and the need for specialized equipment, of existing materials and methods.

### SUMMARY

According to a first aspect, the present disclosure relates to a nanocomposite. In some embodiments, the nanocomposite includes 30 percent by weight (wt. %) to 65 wt. % titanium carbide nanosheets having alkylammonium ions disposed on a surface of the nanosheets, 30 wt. % to 65 wt. % nickel oxide (NiO) nanoparticles, and 2 wt. % to 15 wt. % of a porous carbon-containing biochar, each based on a total weight of nanocomposite.

In some embodiments, the alkylammonium ions are primary alkylammoinium ions having 6 to 20 carbon atoms.

In some embodiments, the titanium carbide nanosheets having alkylammonium ions disposed on a surface of the nanosheets have a carbon content of 10 wt. % to 70 wt. %, based on a total weight of titanium carbide nanosheets having alkylammonium ions disposed on a surface of the nanosheets.

In some embodiments, the titanium carbide nanosheets are nanosheets of a Ti₃C₂ MXene.

In some embodiments, the nickel oxide nanoparticles are NiO nanoparticles.

In some embodiments, the porous carbon-containing biochar is a Coleus amboinicus biochar.

In some embodiments, the Coleus amboinicus biochar is a functionalized Coleus amboinicus biochar including carboxylic acid functional groups.

In some embodiments, the nanocomposite is in the form of particles having a mean particle size of 5 nm to 50 nm, and a particle shape which is at least one selected from a flower petal-like shape, a rhombus shape, and an irregular flake shape.

The present disclosure also relates to a method of forming the nanocomposite. In some embodiments, the method includes heating a nanoparticle preparation mixture including an extract of Coleus amboinicus, nickel nitrate, and a hydroxide base to 250 °C to 350 °C to form the nickel oxide nanoparticles. In some embodiments, the method further includes ultrasonically mixing the nickel oxide nanoparticles with the porous carbon-containing biochar and the titanium carbide nanosheets having alkylammonium ions disposed on a surface of the nanosheets to form a reaction mixture. In some embodiments, the method includes calcining the reaction mixture at 350 °C to 450 °C to form the nanocomposite.

In some embodiments, the extract of Coleus amboinicus is an aqueous extract of Coleus amboinicus.

In some embodiments, the nanoparticle preparation mixture has a molar ratio of nickel nitrate to hydroxide base of 1:1 to 5:1.

In some embodiments, a method includes forming the porous carbon-containing biochar by heating a biochar preparation mixture including water, Coleus amboinicus leaves and a hydroxide base to form a precursor. In some embodiments, the method includes pyrolyzing the precursor to form a Coleus amboinicus biochar.

In some embodiments, the biochar preparation mixture has a concentration of hydroxide base of 2.5 molar (M) to 10 M.

In some embodiments, the biochar preparation mixture is formed by heating the Coleus amboinicus leaves and a hydroxide base in water at 50 °C to 100 °C for 1 hour (h) to 10 hours.

In some embodiments, the method further includes functionalizing the Coleus amboinicus biochar by heating the Coleus amboinicus biochar in an acid mixture including nitric acid (HNO₃) and sulfuric acid (H₂SO₄) to form a functionalized Coleus amboinicus biochar including carboxylic acid groups.

The present disclosure also relates to a method of detecting the presence of a pesticide in a sample. In some embodiments, the method includes immersing a working electrode including the nanocomposite. In some embodiments, the method includes a reference electrode, and a counter electrode in an analyte including the sample, applying a voltage to the working electrode and counter electrode. In some embodiments, the method includes measuring a current response to determine at least one selected from a cathodic peak voltage, an anodic peak voltage, and a steady-state current. In some embodiments, the method includes determining the presence of the pesticide in the analyte based on at least one selected from the group including cathodic peak voltage, the anodic peak voltage, and the steady-state current.

In some embodiments, the analyte includes 0.1 M to 2.5 M potassium hydroxide (KOH).

In some embodiments, the pesticide is at least one selected from the group including glyphosate and captan.

In some embodiments, the method further includes determining a concentration of the pesticide in the analyte based on at least one selected from the group including of the cathodic peak voltage, the anodic peak voltage, and the steady-state current. In some embodiments, the concentration of the pesticide in the analyte is 0.1 nanomolar (nM) to 25 nM.

In some embodiments, the method shows a pesticide response that is 100% to 250% of a response to a non-pesticide selected from the group including urea, ammonium nitrate and calcium nitrate.

The foregoing general description of the illustrative embodiments and the following detailed description thereof are merely exemplary aspects of the teachings of this disclosure and are not restrictive.

### BRIEF DESCRIPTION OF THE DRAWINGS

A more complete appreciation of this disclosure and many of the attendant advantages thereof will be readily obtained as the same becomes better understood by reference to the following detailed description when considered in connection with the accompanying drawings, wherein:

FIG. 1A is a schematic flow chart of a method of forming a nanocomposite, according to certain embodiments.

FIG. 1B is a schematic flow chart of a method of forming a porous carbon-containing biochar, according to certain embodiments.

FIG. 1C is a schematic flow chart of a method of detecting the presence of a pesticide in a sample.

FIG. 2 is a schematic flow chart depicting a method of synthesizing NiO-BC-Mxene nanocomposite, according to certain embodiments.

FIG. 3 illustrates an experimental process for fabricating a nanocomposite sensor, according to certain embodiments.

FIG. 4 shows powder X-ray diffraction (PXRD) spectra of the NiO-Carbon-Mxene nanocomposite, according to certain embodiments.

FIG. 5 shows Fourier transform Infrared (FT-IR) spectra of the NiO-Carbon-Mxene nanocomposite, according to certain embodiments.

FIG. 6A shows field emission scanning electron microscopy (FESEM) micrograph of the NiO-Carbon-Mxene nanocomposite, depicting shape of flower petals, according to certain embodiments.

FIG. 6B shows FESEM micrograph of the NiO-Carbon-Mxene nanocomposite, depicting diamond structure, according to certain embodiments.

FIG. 6C shows a particle size distribution for the NiO-Carbon-Mxene nanocomposite.

FIG. 6D shows FESEM micrograph of the NiO-Carbon-Mxene nanocomposite, depicting small and flat flakes morphology, according to certain embodiments.

FIG. 7A shows transmission electron microscopy (TEM) image of the NiO-Carbon-Mxene nanocomposite at magnification of 50 nm, according to certain embodiments.

FIG. 7B shows TEM image of the NiO-Carbon-Mxene nanocomposite at magnification of 20 nm, according to certain embodiments.

FIG. 7C shows TEM image of the NiO-Carbon-Mxene nanocomposite at magnification of 10 nm, according to certain embodiments.

FIG. 7D shows selected area electron diffraction (SAED) Pattern of the NiO-Carbon-Mxene nanocomposite, according to certain embodiments.

FIG. 7E shows energy dispersive X-ray analysis (EDAX) spectra of the NiO-Carbon-Mxene nanocomposite, according to certain embodiments.

FIG. 8A-8C show the thermogravimetric analysis-differential thermal analysis (TGA-DTA) spectra for the NiO-Carbon-Mxene nanocomposite, according to certain embodiments.

FIG. 9A is a cyclic voltammetry (CV) curve of varying concentrations of glyphosate measured with a NiO-Carbon-Mxene nanocomposite-based electrode, according to certain embodiments.

FIG. 9B is a CV curve for varying concentrations of glyphosate at different time intervals measured with the NiO-Carbon-Mxene nanocomposite-based electrode, according to certain embodiments.

FIG. 9C linear sweep voltammetry (LSV) curve for glyphosate and captan measured with the NiO-Carbon-Mxene nanocomposite-based electrode, according to certain embodiments.

FIG. 9D is a bar graph depicting the selectivity of the NiO-Carbon-Mxene nanocomposite-based electrode for glyphosate against various molecules including urea, ammonium nitrate, and calcium nitrate, according to certain embodiments.

FIG. 9E depicts the amperometric response curve of glyphosate measured with the NiO-Carbon-Mxene nanocomposite-based electrode, according to certain embodiments.

FIG. 10A depicts CV curve for varying concentrations of captan measured with the NiO-Carbon-Mxene nanocomposite-based electrode, according to certain embodiments.

FIG. 10B depicts CV curve for varying concentrations of captan at different time intervals, measured with the NiO-Carbon-Mxene nanocomposite-based electrode, according to certain embodiments.

FIG. 10C depicts LSV curve for glyphosate and captan, measured with the NiO-Carbon-Mxene nanocomposite-based electrode, according to certain embodiments.

FIG. 10D is a bar graph depicting the selectivity of the NiO-Carbon-Mxene nanocomposite-based electrode for captan against various molecules including urea, ammonium nitrate, and calcium nitrate, according to certain embodiments.

FIG. 10E depicts amperometric response curve of captan measured with the NiO-Carbon-Mxene nanocomposite-based electrode, according to certain embodiments.

### DETAILED DESCRIPTION

In the drawings, like reference numerals designate identical or corresponding parts throughout the several views. Further, as used herein, the words “a,” “an” and the like generally carry a meaning of “one or more,” unless stated otherwise.

Furthermore, the terms “approximately,” “approximate,” “about,” and similar terms generally refer to ranges that include the identified value within a margin of 20%, 10%, or preferably 5%, and any values therebetween.

The present disclosure is intended to include all hydration states of a given compound or formula unless otherwise noted or when heating a material.

As used herein, the term ‘nanoparticle’ refers to a particle whose longest diameter is less than or equal to 1000 nanometers.

As used herein, the term ‘biochar’ refers to a carbon-rich material produced by heating organic materials like plant biomass in the absence or limited presence of oxygen. Typically, biochar is a porous material and may be characterized by ratios of various constituent elements, such as a H/C ratio or O/C ratio.

As used herein, the term ‘porous’ refers to the presence of numerous tiny voids or holes (pores) within the material, which may significantly increase its surface area.

As used herein, the term ‘carbon-containing’ emphasizes that the biochar's composition is predominantly carbon, which is responsible for many of its beneficial properties, such as high chemical stability, adsorption capability, and resistance to degradation.

As used herein, ‘functional group’ indicates specific groups of atoms within a molecular structure that are accountable for the characteristic chemical reactions and chemical properties of that structure. Suitable examples of functional groups include hydrocarbons, groups containing halogen, groups containing oxygen (alcohol, acid, ketone, aldehydes), groups containing nitrogen (nitrile, amines, amides), groups containing silicon (silanes) and groups containing phosphorus and sulfur all identifiable by a skilled artisan.

As used herein, the term ‘cathodic peak voltage’ refers to the potential at which the maximum reduction current occurs during a cyclic voltammetry scan. It represents the point where an electroactive species gains electrons (reduction process) and reaches its highest current intensity on the cathodic side of the voltammogram.

As used herein, the term ‘anodic peak voltage’ is the potential at which the maximum oxidation current is observed during a cyclic voltammetry scan. It signifies the point where the electroactive species loses electrons (oxidation process) and reaches its highest current intensity on the anodic side of the voltammogram.

As used herein, the term ‘steady-state current’ is the constant current value achieved after the transient effects in an electrochemical system have diminished. This current is observed once the system has stabilized, often indicating a balanced rate of oxidation and reduction or a consistent electrochemical reaction under given conditions.

As used herein, the term ‘alkylammonium ions’ refer to positively charged ions (cations) that contain an ammonium group, where one or more of the hydrogen atoms have been replaced by alkyl groups (hydrocarbon chains). These alkyl groups can be, for example, methyl, ethyl and so on; or octyl, dodecyl and so on, carbon chains.

A pesticide is a substance meant to prevent, destroy, or control pests including, but not limited to algae, bacteria, fungi, plants, insects, mites, snails, rodents, and viruses.

A pesticide intended for use against algae is known as an algicide. Examples of algicides include benzalkonium chloride, bethoxazin, cybutryne, dichlone, dichlorophen, diuron, endothal, fentin, isoproturon, methabenthiazuron, nabam, oxyfluorfen, pentachlorophenyl laurate, quinoclamine, quinonamid, simazine, terbutryn, and tiodonium.

A pesticide intended for use against bacteria is known as a bactericide. Examples of bactericides include antibiotics such as: aminoglycosides such as amikacin, gentamicin, kanamycin, neomycin, netilmicin, tobramycin, paromomycin, streptomycin, and spectinomycin; ansamycins such as geldanamycin, herbimycin, and rifaximin; carbacephems such as loracarbef; carbapenems such as ertapenem, doripenem, imipenem, and meropenem; cephalosporins such as cefadroxil, cefazolin, cephradine, cephapirin, cephalothin, cephalexin, cefaclor, cefoxitin, cefotetan, cefamandole, cefmetazole, cefonicid, cefprozil, cefuroxime, cefixime, cefdinir, cefditoren, cefoperazone, cefotaxime, cefpodoxime, cefazidime, ceftibuten, ceftizoxime, moxalactam, ceftriaxone, cefepime, cefaroline fosamil, and ceftobiprole; glycopeptides such as teicoplanin, vancomycin, telavancin, dalbavancin, and oritavancin; lincosamides such as clindamycin and lincomycin; lipopeptides such as daptomycin; macrolides such as azithromycin, clarithromycin, erythromycin, roxithromycin, telithromycin, spiramycin, and fidoxamicin; monobactams such as aztreonam; nitrofurans such as furazolidone and nitrofurantoin; oxazolidinones such as linezolid, posizolid, radezolid, and torezolid; penicillins such as amoxicillin, ampicillin, azlocillin, dicloxacillin, flucloxacillin, mezlocillin, methicillin, nafcillin, oxacillin, penicillins (including penicillin G and V), piperacillin, temocillin, and ticarcillin; polypeptides such as bacitracin, colistin, and polymyxin B; quinolones such as ciproflaxacin, enoxacin, gatifloxacin, gemifloxacin, levofloxacin, lomefloxacin, moxifloxacin, nadifloxacin, nalidixic acid, norfloxacin, ofloxacin, trovafloxacin, gepafloxacin, sparfloxacin, and temafloxacin; sulfonamides such as mafenide, sulfacetamide, sulfadiazine, sulfadithoxine, sulfamethizole, sulfamethoxazole, sulfanilamide, sulfasalazine, sulfisoxazole, and sulfonamidochrysoidine; tetracyclines such as demeclocycline, doxycycline, metacycline, minocycline, oxytetracycline, and tetracycline.

A pesticide intended for use against fungi is known as a fungicide. Examples of fungicides include acibenzolar, acypetacs, aldimorph, anilazine, aureofungin, azaconazole, azithiram, azoxystrobin, benalaxyl, benodanil, benomyl, benquinox, benthiavalicarb, binapacryl, biphenyl, bitertanol, bixafen, blasticidin-S, boscalid, bromuconazole, captafol, captan, carbendazim, carboxin, carpropamid, chloroneb, chlorothalonil, chlozolinate, cyazofamid, cymoxanil, cyprodinil, dichlofluanid, diclocymet, dicloran, diethofencarb, difenoconazole, diflumetorim, dimethachlone, dimethomorph, diniconazole, dinocap, dodemorph, edifenphos, enoxastrobin, epoxiconazole, etaconazole, ethaboxam, ethirimol, etridiazole, famoxadone, fenamidone, fenarimol, fenbuconazole, fenfuram, fenhexamid, fenoxanil, fenpropidin, fenpropimorph, ferbam, fluazinam, fludioxonil, flumorph, fluopicolide, fluopyram, fluoroimide, fluoxastrobin, flusilazole, flutianil, flutolain, flopet, fthalide, furalaxyl, guazatine, hexaconazole, hymexazole, imazalil, imibenconazole, iminoctadine, iodocarb, ipconazole, iprobenfos, iprodione, iprovalicarb, siofetamid, isoprothiolane, isotianil, kasugamycin, laminarin, mancozeb, mandestrobin, mandipropamid, maneb, mepanypyrim, mepronil, meptyldinocap, mealaxyl, metominostrobin, metconazole, methafulfocarb, metiram, metrafenone, myclobutanil, naftifine, nuarimol, octhilinone, ofurace, orysastrobin, oxadixyl, oxathiapiprolin, oxolinic acid, oxpoconazole, oxycarboxin, oxytetracycline, pefurazate, penconazole, pencycuron, penflufen, penthiopyrad, phenamacril, picarbutrazox, picoxystrobin, piperalin, polyoxin, probenzole, prochloraz, procymidone, propamocarb, propiconazole, propineb, proquinazid, prothiocarb, prothioconazole, pydiflumetofen, pyraclostrobin, pyrametostrobin, pyraoxystrobin, pyrazophos, pyribencarb, pyributicarb, pyrifenox, pyrimethanil, pyrimorph, pyriofenone, pyroquilon, quinoxyfen, quintozene, sedaxane, silthiofam, simeconazole, spiroxamine, streptomycin, tebuconazole, tebufloquin, teclofthalam, tecnazene, terbinafine, tetraconazole, thiabendazole, thifluzamide, thiphanate, thiram, tiadinil, tolclosfos-methyl, folfenpyrid, tolprocarb, tolylfluanid, triadimefon, triadimenol, triazoxide, triclopyricarb, tricyclazole, tridemorph, trifloxystrobin, triflumizole, triforine, validamycin, and vinclozolin.

A pesticide intended for use against plants is known as an herbicide as described above.

A pesticide intended for use against insects is known as an insecticide. Examples of insecticides are: organochlorides such as Aldrin, chlordane, chlordecone, DDT, dieldrin, endofulfan, endrin, heptachlor, hexachlorobenzene, lindane, methoxychlor, mirex, pentachlorophenol, and TDE; organophosphates such as acephate, azinphos-methyl, bensulide, chlorethoxyfos, chlorpyrifos, diazinon, chlorvos, dicrotophos, dimethoate, disulfoton, ethoprop, fenamiphos, fenitrothion, fenthion, malathion, methamdophos, methidathion, mevinphos, monocrotophos, naled, omethoate, oxydemeton-methyl, parathion, phorate, phosalone, phosmet, phostebupirim, phoxim, pirimiphos-methyl, profenofos, terbufos, and trichlorfon; carbamates such as aldicarb, bendiocarb, carbofuran, carbaryl, dioxacarb, fenobucarb, fenoxycarb, isoprocarb, methomyl; pyrethroids such as allethrin, bifenthrin, cyhalothrin, cypermethrin, cyfluthrin, deltamethrin, etofenprox, fenvalerate, permethrin, phenothrin, prallethrin, resmethrin, tetramethrin, tralomethrin, and transfluthrin; neonicotinoids such as acetamiprid, clothiandin, imidacloprid, nithiazine, thiacloprid, and thiamethoxam; ryanoids such as chlorantraniliprole, cyanthaniliprole, and flubendiamide.

A pesticide intended for use against mites is known as a miticide. Examples of miticides are permethrin, ivermectin, carbamate insecticides as described above, organophosphate insecticides as described above, dicofol, abamectin, chlorfenapyr, cypermethrin, etoxazole, hexythiazox, imidacloprid, propargite, and spirotetramat.

A pesticide intended for use against snails and other mollusks is known as a molluscicide. Examples of molluscicides are metaldehyde and methiocarb.

A pesticide intended for use against rodents is known as a rodenticide. Examples of rodenticides are warfarin, coumatetralyl, difenacoum, brodifacoum, flocoumafen, bromadiolone, diphacinone, chlorophacinone, pindone, difethialone, cholecalciferol, ergocalciferol, ANTU, chloralose, crimidine, 1,3-difluoro-2-propanol, endrin, fluroacetamide, phosacetim, pyrinuron, scilliroside, strychnine, tetramethylenedisulfotetramine, bromethalin, 2,4-dinitrophenol, and uragan D2.

A pesticide intended for use against viruses is known as a virucide. Examples of virucides are cyanovirin-N, griffithsin, interferon, NVC-422, scytovirin, urumin, virkon, zonroz, and V-bind viricie.

As used herein, the term ‘analyte’ is a substance or chemical compound that is being measured or analysed in a sample, typically in the context of scientific experiments, chemical analysis, or medical testing. It is the component whose concentration or presence is being determined through various analytical methods.

A weight percent of a component, unless specifically stated to the contrary, is based on the total weight of the formulation or composition in which the component is included. For example, if a particular element or component in a composition or article is said to have 5 wt. %, it is understood that this percentage is in relation to a total compositional percentage of 100%.

The present disclosure is intended to include all isotopes of a given compound or formula, unless otherwise noted. The present disclosure is intended to include all hydration states of a given compound or formula, unless otherwise noted or when heating a material.

The present disclosure relates to a nanocomposite. The nanocomposite may be fabricated through green chemistry methods and/or generally environmentally friendly techniques or procedures. The prepared nanocomposite is used to fabricate an electrochemical biosensor for the detection of most hazardous pesticides such as glyphosate, and captan in low concentrations (nM concentrations). The fabricated sensors show fast response and recovery time, excellent stability over a long period of operation.

According to a first aspect, the present disclosure relates to a nanocomposite. In some embodiments, the nanocomposite includes titanium carbide nanosheets, nickel oxide nanoparticles, and a porous carbon-containing biochar.

In some embodiments, the titanium carbide nanosheets are present in the nanocomposite in an amount of 30 to 65 wt. %, based on a total weight of the nanocomposite. For example, the titanium carbide nanosheets may be preset at 30 wt. %, 32.5 wt. %, 35 wt. %, 37.5 wt. %, 40 wt. %, 42.5 wt. %, 45 wt. %, 47.5 wt. %, 50 wt. %, 52.5 wt. %, 55 wt. %, 57.5 wt. %, 60 wt. %, 62.5 wt. %, or 65 wt. %, based on a total weight of the nanocomposite.

In some embodiments, the titanium carbide nanosheets have alkylammonium ions disposed on a surface of the nanosheets. In some embodiments, the alkyl group in the alkylammonium ions have about 6 to 20 carbon atoms. As used herein, the term “alkyl”, as used herein, unless otherwise specified, refers to a straight, branched, or cyclic, aliphatic fragment having 6 to 20 carbon atoms. Non-limiting examples include, but are not limited to, methyl, ethyl, propyl, isopropyl, butyl, isobutyl, t-butyl, pentyl, isopentyl, neopentyl, hexyl, isohexyl, 3-methylpentyl, 2,2-dimethylbutyl, 2,3-dimethylbutyl, lauryl, myristyl, cetyl, stearyl, and the like, including guerbet-type alkyl groups (e.g., 2-methylpentyl, 2-ethylhexyl, 2-proylheptyl, 2-butyloctyl, 2-pentylnonyl, 2-hexyldecyl, 2-heptylundecyl, 2-octyldodecyl, 2-nonyltridecyl, 2-decyltetradecyl, and 2-undecylpentadecyl), and unsaturated alkenyl and alkynyl variants such as vinyl, allyl, 1-propenyl, 2-propenyl, 1-butenyl, 2-butenyl, 3-butenyl, 1-pentenyl, 2-pentenyl, 3-pentenyl, 4-pentenyl, 1-hexenyl, 2-hexenyl, 3-hexenyl, 4-hexenyl, 5-hexenyl, and the like. Cycloalkyl is a type of cyclized alkyl group. Exemplary cycloalkyl groups include, but are not limited to, cyclopropyl, cyclobutyl, cyclopentyl, cyclohexyl, norbornyl, and adamantyl. The term “lower alkyl” is used herein to describe alkyl groups having 1 to 5 carbon atoms (e.g., methyl, ethyl, n-propyl, etc. In some embodiments, the alkylammonium ions comprise a hexacecyl group. In some embodiments, the alkylammonium ions are hexadecylammonium ions.

In some embodiments, the titanium carbide nanosheets functionalized with alkylammonium ions have a carbon content of 10 to 70 wt. %, based on a total weight of the titanium carbide nanosheets functionalized with alkylammonium ions. For example, the titanium carbide nanosheets functionalized with alkylammonium ions may have a carbon content of 10 wt. %, 12.5 wt. %, 15 wt. %, 17.5 wt. %, 20 wt. %, 22.5 wt. %, 25 wt. %, 27.5 wt. %, 30 wt. %, 32.5 wt. %, 35 wt. %, 37.5 wt. %, 40 wt. %, 42.5 wt. %, 45 wt. %, 47.5 wt. %, 50 wt. %, 52.5 wt. %, 55 wt. %, 57.5 wt. %, 60 wt. %, 62.5 wt. %, 65 wt. %, 67.5 wt. %, or 70 wt. %, based on a total weight of the titanium carbide nanosheets functionalized with alkylammonium ions. This functionalization with alkylammonium ions may be advantageous for improving dispersion, stability, and/or the titanium carbide's interaction with other components in the nanocomposite.

In some embodiments, the titanium carbide nanosheets are nanosheets of a Ti₃C₂ MXene. In some embodiments, the Ti₃C₂ MXene is in the form of delaminated layered flakes. In some embodiments, the flakes have the longest dimension of 0.01 to 100 μm. For example, the flakes may have a longest dimension of 0.01 μm, 0.025 μm, 0.05 μm, 0.075 μm, 0.1 μm, 0.125 μm, 0.150 μm, 0.175 μm, 0.2 μm, 0.225 μm, 0.250 μm, 0.275 μm, 0.3 μm, 0.325 μm, 0.350 μm, 0.375 μm, 0.4 μm, 0.425 μm, 0.450 μm, 0.475 μm, 0.5 μm, 0.525 μm, 0.550 μm, 0.575 μm, 0.6 μm, 0.625 μm, 0.650 μm, 0.675 μm, 0.7 μm, 0.725 μm, 0.750 μm, 0.775 μm, 0.8 μm, 0.825 μm, 0.850 μm, 0.875 μm, 0.9 μm, 0.925 μm, 0.950 μm, 0.975 μm, 1.0 μm, 1.5 μm, 2.0 μm, 2.5 μm, 3.0 μm, 3.5 μm, 4.0 μm, 4.5 μm, 5 μm, 7.5 μm, 10 μm, 12.5 μm, 15 μm, 17.5 μm, 20 μm, 25 μm, 30 μm, 35 μm, 40 μm, 45 μm, 50 μm, 55 μm, 60 μm, 65 μm, 70 μm, 75 μm, 80 μm, 85 μm, 90 μm, 95 μm, or 100 μm. In some embodiments, the flakes have a thickness of 1 to 100 nanometers (nm). For example the flake may have a thickness of 1 nm, 1.25 nm, 1.5 nm, 1.75 nm, 2.0 nm, 2.5 nm, 3.0 nm, 3.5 nm, 4.0 nm, 4.5 nm, 5.0 nm, 5.5 nm, 6.0 nm, 6.5 nm, 7.0 nm, 7.5 nm, 8.0 nm, 8.5 nm, 9.0 nm, 9.5 nm, 10 nm, 11 nm, 12 nm, 13 nm, 14 nm, 15 nm, 16 nm, 17 nm, 18 nm, 19 nm, 20 nm, 21 nm, 22 nm, 23 nm, 24 nm, 25 nm, 30 nm, 35 nm, 40 nm, 45 nm, 50 nm, 55 nm, 60 nm, 65 nm, 70 nm, 75 nm, 80 nm, 85 nm, 90 nm, 95 nm, or 100 nm. In some embodiments, the flakes are stacked directly on top of one another.

In some embodiments, the nickel oxide nanoparticles are present in an amount of 30 to 65 wt. %, based on a total weight of the nanocomposite. For example, the nickel oxide nanoparticles may be preset at 30 wt. %, 32.5 wt. %, 35 wt. %, 37.5 wt. %, 40 wt. %, 42.5 wt. %, 45 wt. %, 47.5 wt. %, 50 wt. %, 52.5 wt. %, 55 wt. %, 57.5 wt. %, 60 wt. %, 62.5 wt. %, or 65 wt. %, based on a total weight of the nanocomposite. In some embodiments, the nickel oxide nanoparticles are NiO nanoparticles. In some embodiments, the NiO nanoparticles are crystalline by PXRD. In some embodiments, the NiO nanoparticles crystallize in a face-centered cubic (FCC) structure.

In general, the nickel oxide nanoparticles can be any shape known to one of ordinary skill in the art. Examples of suitable shapes the nickel oxide nanoparticles may take include spheres, spheroids, lentoids, ovoids, solid polyhedra such as tetrahedra, cubes, octahedra, icosahedra, dodecahedra, hollow polyhedra (also known as nanocages), stellated polyhedra (both regular and irregular, also known as nanostars), triangular prisms (also known as nanotriangles), hollow spherical shells (also known as nanoshells), tubes (also known as nanotubes), nanosheets, nanoplatelets, nanodisks, rods (also known as nanorods), and mixtures thereof. In the case of nanorods, the rod shape may be defined by a ratio of a rod length to a rod width, the ratio being known as the aspect ratio. For nickel oxide nanoparticles of the current invention, nanorods should have an aspect ratio less than 1000, preferably less than 750, preferably less than 500, preferably less than 250, preferably less than 100, preferably less than 75, preferably less than 50, preferably less than 25.

In some embodiments, the nickel oxide nanoparticles have uniform shape. Alternatively, the shape may be non-uniform. As used herein, the term “uniform shape” refers to an average consistent shape that differs by no more than 10%, by no more than 5%, by no more than 4%, by no more than 3%, by no more than 2%, by no more than 1% of the distribution of nickel oxide nanoparticles having a different shape. As used herein, the term “non-uniform shape” refers to an average consistent shape that differs by more than 10% of the distribution of nickel oxide nanoparticles having a different shape. In one embodiment, the shape is uniform and at least 90% of the nickel oxide nanoparticles are spherical or substantially circular, and less than 10% are polygonal. In another embodiment, the shape is non-uniform and less than 90% of the nickel oxide nanoparticles are spherical or substantially circular, and greater than 10% are polygonal.

In some embodiments, the nickel oxide nanoparticles have a mean particle size of 5 to 100 nm, preferably 7.5 to 75 nm, preferably 10 to 60 nm, preferably 12.5 to 50 nm, preferably 15 to 40 nm, preferably 15.5 to 35 nm, preferably about 16 to 32 nm. In embodiments where the nickel oxide nanoparticles are spherical, the particle size may refer to a particle diameter. In embodiments where the nickel oxide nanoparticles are polyhedral or some other non-spherical shape, the particle size may refer to the diameter of a circumsphere. In some embodiments, the particle size refers to a mean distance from a particle surface to particle centroid or center of mass. In alternative embodiments, the particle size refers to a maximum distance from a particle surface to a particle centroid or center of mass. In some embodiments where the nickel oxide nanoparticles have an anisotropic shape such as nanorods, the particle size may refer to a length of the nanorod, a width of the nanorod, or an average of the length and width of the nanorod. In some embodiments in which the nickel oxide nanoparticles have non-spherical shapes, the particle size refers to the diameter of a sphere having an equivalent volume as the particle. In some embodiments in which the nickel oxide nanoparticles have non-spherical shapes, the particle size refers to the diameter of a sphere having an equivalent diffusion coefficient as the particle.

In some embodiments, the nickel oxide nanoparticles of the present disclosure are monodisperse, having a coefficient of variation or relative standard deviation, expressed as a percentage and defined as the ratio of the particle size standard deviation (σ) to the particle size mean (μ) multiplied by 100 of less than 25%, preferably less than 10%, preferably less than 8%, preferably less than 6%, preferably less than 5%, preferably less than 4%, preferably less than 3%, preferably less than 2%. In some embodiments, the nickel oxide nanoparticles of the present disclosure are monodisperse having a particle size distribution ranging from 80% of the average particle size to 120% of the average particle size, preferably 90-110%, preferably 95-105% of the average particle size. In some embodiments, the nickel oxide nanoparticles are not monodisperse.

In general, the particle size may be determined by any suitable method known to one of ordinary skill in the art. In some embodiments, the particle size is determined by powder X-ray diffraction (PXRD). Using PXRD, the particle size may be determined using the Scherrer equation, which relates the full-width at half-maximum (FWHM) of diffraction peaks to the size of regions comprised of a single crystalline domain (known as crystallites) in the sample. In some embodiments, the crystallite size is the same as the particle size. For accurate particle size measurement by PXRD, the particles should be crystalline, comprise only a single crystal, and lack non-crystalline portions. Typically, the crystallite size underestimates particle size compared to other measures due to factors such as amorphous regions of particles, the inclusion of non-crystalline material on the surface of particles such as bulky surface ligands, and particles which may be composed of multiple crystalline domains. In some embodiments, the particle size is determined by dynamic light scattering (DLS). DLS is a technique which uses the time-dependent fluctuations in light scattered by particles in suspension or solution in a solvent, typically water to measure a size distribution of the particles. Due to the details of the DLS setup, the technique measures a hydrodynamic diameter of the particles, which is the diameter of a sphere with an equivalent diffusion coefficient as the particles. The hydrodynamic diameter may include factors not accounted for by other methods such as non-crystalline material on the surface of particles such as bulky surface ligands, amorphous regions of particles, and surface ligand-solvent interactions. Further, the hydrodynamic diameter may not accurately account for non-spherical particle shapes. DLS does have an advantage of being able to account for or more accurately model solution or suspension behavior of the particles compared to other techniques. In some embodiments, the particle size is determined by electron microscopy techniques such as scanning electron microscopy (SEM) or transmission electron microscopy (TEM).

In some embodiments, the porous carbon-containing biochar is present in an amount of 2 to 15 wt. %, based on a total weight of nanocomposite. For example, the porous carbon-containing biochar may be present in an amount of 2.0 wt. %, 2.25 wt. %, 2.5 wt. %, 2.75 wt. %, 3.0 wt. %, 3.25 wt. %, 3.5 wt. %, 3.75 wt. %, 4.0 wt. %, 4.25 wt. %, 4.5 wt. %, 4.75 wt. %, 5.0 wt. %, 5.25 wt. %, 5.5 wt. %, 5.75 wt. %, 6.0 wt. %, 6.25 wt. %, 6.5 wt. %, 6.75 wt. %, 7.0 wt. %, 7.25 wt. %, 7.5 wt. %, 7.75 wt. %, 8.0 wt. %, 8.25 wt. %, 8.5 wt. %, 8.75 wt. %, 9.0 wt. %, 9.25 wt. %, 9.5 wt. %, 9.75 wt. %, 10.0 wt. %, 10.25 wt. %, 10.5 wt. %, 10.75 wt. %, 11.0 wt. %, 11.25 wt. %, 11.5 wt. %, 11.75 wt. %, 12.0 wt. %, 12.25 wt. %, 12.5 wt. %, 12.75 wt. %, 13.0 wt. %, 13.25 wt. %, 13.5 wt. %, 13.75 wt. %, 14.0 wt. %, 14.25 wt. %, 14.5 wt. %, 14.75 wt. %, or 15.0 wt. %, based on a total weight of the nanocomposite.

In an embodiment, the porous carbon-containing biochar is Coleus amboinicus biochar. In some embodiments, the Coleus amboinicus biochar is a functionalized Coleus amboinicus biochar including carboxylic acid functional groups. In some embodiments, the biochar can be prepared from other plant materials such as wood, agricultural residues, or other biomass sources. The choice of feedstock depends on the desired properties of the biochar, such as surface area, porosity, and chemical composition.

In some embodiments, the porous carbon-containing biochar is present as particles. In general, the porous carbon-containing biochar particles can be any shape known to one of ordinary skill in the art. Examples of suitable shapes the porous carbon-containing biochar particles may take include spheres, spheroids, lentoids, ovoids, solid polyhedra such as tetrahedra, cubes, octahedra, icosahedra, dodecahedra, hollow polyhedra (also known as nanocages), stellated polyhedra (both regular and irregular, also known as nanostars), triangular prisms (also known as nanotriangles), hollow spherical shells (also known as nanoshells), tubes (also known as nanotubes), nanosheets, nanoplatelets, nanodisks, rods (also known as nanorods), and mixtures thereof. In the case of nanorods, the rod shape may be defined by a ratio of a rod length to a rod width, the ratio being known as the aspect ratio. For porous carbon-containing biochar particles of the current invention, nanorods should have an aspect ratio less than 1000, preferably less than 750, preferably less than 500, preferably less than 250, preferably less than 100, preferably less than 75, preferably less than 50, preferably less than 25.

In some embodiments, the porous carbon-containing biochar particles have uniform shape. Alternatively, the shape may be non-uniform. As used herein, the term “uniform shape” refers to an average consistent shape that differs by no more than 10%, by no more than 5%, by no more than 4%, by no more than 3%, by no more than 2%, by no more than 1% of the distribution of porous carbon-containing biochar particles having a different shape. As used herein, the term “non-uniform shape” refers to an average consistent shape that differs by more than 10% of the distribution of porous carbon-containing biochar particles having a different shape. In one embodiment, the shape is uniform and at least 90% of the porous carbon-containing biochar particles are spherical or substantially circular, and less than 10% are polygonal. In another embodiment, the shape is non-uniform and less than 90% of the porous carbon-containing biochar particles are spherical or substantially circular, and greater than 10% are polygonal.

In some embodiments, the porous carbon-containing biochar particles have a mean particle size of 0.01 to 100 μm. For example, the porous carbon-containing biochar particles may have a mean particle size of 0.01 μm, 0.025 μm, 0.05 μm, 0.075 μm, 0.1 μm, 0.125 μm, 0.150 μm, 0.175 μm, 0.2 μm, 0.225 μm, 0.250 μm, 0.275 μm, 0.3 μm, 0.325 μm, 0.350 μm, 0.375 μm, 0.4 μm, 0.425 μm, 0.450 μm, 0.475 μm, 0.5 μm, 0.525 μm, 0.550 μm, 0.575 μm, 0.6 μm, 0.625 μm, 0.650 μm, 0.675 μm, 0.7 μm, 0.725 μm, 0.750 μm, 0.775 μm, 0.8 μm, 0.825 μm, 0.850 μm, 0.875 μm, 0.9 μm, 0.925 μm, 0.950 μm, 0.975 μm, 1.0 μm, 1.5 μm, 2.0 μm, 2.5 μm, 3.0 μm, 3.5 μm, 4.0 μm, 4.5 μm, 5 μm, 7.5 μm, 10 μm, 12.5 μm, 15 μm, 17.5 μm, 20 μm, 25 μm, 30 μm, 35 μm, 40 μm, 45 μm, 50 μm, 55 μm, 60 μm, 65 μm, 70 μm, 75 μm, 80 μm, 85 μm, 90 μm, 95 μm, or 100 μm. In embodiments where the porous carbon-containing biochar particles are spherical, the particle size may refer to a particle diameter. In embodiments where the porous carbon-containing biochar particles are polyhedral or some other non-spherical shape, the particle size may refer to the diameter of a circumsphere. In some embodiments, the particle size refers to a mean distance from a particle surface to particle centroid or center of mass. In alternative embodiments, the particle size refers to a maximum distance from a particle surface to a particle centroid or center of mass. In some embodiments where the porous carbon-containing biochar particles have an anisotropic shape such as nanorods, the particle size may refer to a length of the nanorod, a width of the nanorod, or an average of the length and width of the nanorod. In some embodiments in which the porous carbon-containing biochar particles have non-spherical shapes, the particle size refers to the diameter of a sphere having an equivalent volume as the particle. In some embodiments in which the porous carbon-containing biochar particles have non-spherical shapes, the particle size refers to the diameter of a sphere having an equivalent diffusion coefficient as the particle.

In some embodiments, the porous carbon-containing biochar particles of the present disclosure are monodisperse, having a coefficient of variation or relative standard deviation, expressed as a percentage and defined as the ratio of the particle size standard deviation (σ) to the particle size mean (μ) multiplied by 100 of less than 25%, preferably less than 10%, preferably less than 8%, preferably less than 6%, preferably less than 5%, preferably less than 4%, preferably less than 3%, preferably less than 2%. In some embodiments, the porous carbon-containing biochar particles of the present disclosure are monodisperse having a particle size distribution ranging from 80% of the average particle size to 120% of the average particle size, preferably 90-110%, preferably 95-105% of the average particle size. In some embodiments, the porous carbon-containing biochar particles are not monodisperse.

In some embodiments, the porous carbon-containing biochar comprises a 3D framework of activated carbon. This 3D framework may comprise structural members made of activated carbon and a network of pores formed by the structural members. The pores may have any suitable shape, such as spherical, elliptical, polyhedral, or combinations or portions thereof. The pores may have an arrangement which is ordered or disordered. The 3D framework may comprise an ordered arrangement of structural members. Alternatively, the 3D framework may comprise a disordered arrangement of structural members. The 3D framework may have a total volume which is a sum of a structural member volume and a pore volume. The structural member volume refers to a total volume of the 3D framework which is taken up by the structural members. Similarly, the pore volume refers to a total volume of the 3D framework which is taken up by the pores. In some embodiments, the structural member volume is larger than the pore volume. In some embodiments, the pore volume is larger than the structural member volume. In some embodiments, the structural member volume and the pore volume are substantially the same (i.e. within about 10%, preferably within about 5%).

The pores may be monodisperse, that is having a coefficient of variation or relative standard deviation, expressed as a percentage and defined as the ratio of the particle size standard deviation (σ) to the particle size mean (μ) multiplied by 100 of less than 25%, preferably less than 10%, preferably less than 8%, preferably less than 6%, preferably less than 5%, preferably less than 4%, preferably less than 3%, preferably less than 2%. In some embodiments, the pores are not monodisperse.

In some embodiments, the 3D framework causes the particles to have a surface which is defined by cavities, incomplete or partial pores, ridges, ripples, undulations, or other non-smooth or non-uniform textures.

In some embodiments, the porous carbon-containing biochar comprises 70 to 92.5 wt % carbon. For example, the porous carbon-containing biochar can include 70 wt. % 72.5 wt %, 75 wt. %, 77.5 wt. %, 80 wt. %, 82.5 wt. %, 85 wt. %, 87.5 wt. %, 90 wt. %, or 92.5 wt. % carbon, based on a total weight of porous carbon-containing biochar. In some embodiments, the porous carbon-containing biochar comprises 7 to 23 wt % oxygen. For example, the porous carbon-containing biochar may contain 7 wt. %, 8 wt. %, 9 wt %, 10 wt. %, 11 wt. %, 12 wt. %, 13 wt. %, 14 wt. %, 15 wt. %, 16 wt. %, 17 wt. % 18 wt. %, 19 wt. %, 20 wt. %, 21 wt. %, 22 wt. %, or 23 wt. % oxygen, based on a total weight of porous carbon-containing biochar. In some embodiments the porous carbon-containing biochar may include other elements, such as nitrogen, sulfur, hydrogen, phosphorous, calcium, iron, magnesium, and the like.

In some embodiments, the nanocomposite has a weight ratio of titanium carbide nanosheets to nickel oxide nanoparticles of 0.05:1 to 0.5:1. For example, the weight ratio of titanium carbide nanosheets to nickel oxide nanoparticles may be 0.05:1, 0.075:1, 0.1:1, 0.125:1, 0.15:1, 0.175:1, 0.2:1, 0.225:1, 0.25:1, 0.275:1, 0.3:1, 0.325:1, 0.35:1, 0.375:1, 0.4:1, 0.425:1, 0.45:1, 0.475:1, or 0.5:1.

In some embodiments, the nanocomposite has a weight ratio of titanium carbide nanosheets to porous carbon-containing biochar of 0.05:1 to 0.5:1. For example, the weight ratio of titanium carbide nanosheets to porous carbon-containing biochar may be 0.05:1, 0.075:1, 0.1:1, 0.125:1, 0.15:1, 0.175:1, 0.2:1, 0.225:1, 0.25:1, 0.275:1, 0.3:1, 0.325:1, 0.35:1, 0.375:1, 0.4:1, 0.425:1, 0.45:1, 0.475:1, or 0.5:1.

In some embodiments, the nanocomposite has a weight ratio of nickel oxide nanoparticles to porous carbon-containing biochar of 5:1 to 1:5. For example, the weight ratio of nickel oxide nanoparticles to porous carbon-containing biochar may be 5.0:1, 4.5:1, 4.0:1, 3.5:1, 3.0:1, 2.5:1, 2.0:1, 1.5:1, 1.25:1, 1.1:1, 1.0:1.0, 1:1.1, 1:1.25, 1:1.5, 1:2.0, 1:2.5, 1:3.0, 1:3.5, 1:4.0, 1:4.5, or 1:5.0.

In some embodiments, the morphology of the nanocomposite may be nanowires, nanospheres, nanocrystals, nanorectangles, nanotriangles, nanopentagons, nanohexagons, nanoprisms, nanodisks, nanocubes, nanoribbons, nanoblocks, nanotoroids, nanodiscs, nanobarrels, nanogranules, nanowhiskers, nanoflakes, nanofoils, nanopowders, nanoboxes, nanobeads, nanobelts, nano-urchins, nanoflowers, nanostars, tetrapods, etc., and mixtures thereof.

In some embodiments, nanocomposite is in the form of particles having a mean particle size of 5 to 50 nm. For example, the nanocomposite may have a mean particle size of 5 nm, 7.5 nm, 10 nm, 12.5 nm, 15 nm, 17.5 nm, 20 nm, 22.5 nm, 25 nm, 27.5 nm, 30 nm, 32.5 nm, 35 nm, 37.5 nm, 40 nm, 42.5 nm, 45 nm, 47.5 nm, or 50 nm. In some embodiments, nanocomposite is in the form of particles having particle shape which is at least one selected from a flower petal-like shape, a rhombus shape, and an irregular flake shape. Other morphologies of the particle may include spherical, needle-like, cubic, prismatic, disc-like, and sheet-like shapes. In some embodiments, the morphology of the particle is flat flake.

In some embodiments, the titanium carbide nanosheets are disposed on the porous carbon-containing biochar. The titanium carbide nanosheets can be disposed on an outer surface of the porous carbon-containing biochar, an inner surface of the porous carbon-containing biochar (e.g., within the pores), or a combination of these. In some embodiments the nickel oxides nanoparticles are disposed on the porous carbon-containing biochar. The nickel oxides nanoparticles can be disposed on an outer surface of the porous carbon-containing biochar, an inner surface of the porous carbon-containing biochar (e.g., within the pores), or a combination of these. In some embodiments, the nickel oxide nanoparticles are disposed on a surface of the titanium carbide nanosheets. In some embodiments, the titanium carbide nanosheets are disposed on a surface of the nickel oxide nanoparticles. In some embodiments, the nickel oxide nanoparticles are disposed between the porous carbon-containing biochar and the titanium carbide nanosheets. In some embodiments, the nickel oxide nanoparticles are disposed between the nanosheets of the titanium carbide nanosheets as an intercalating layer.

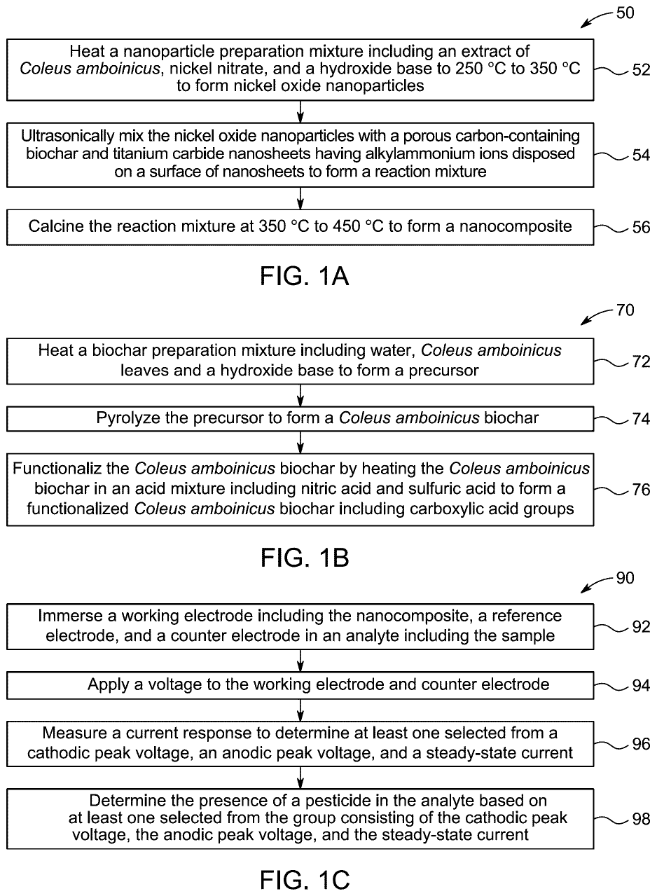

The present disclosure also relates to a method of forming the nanocomposite. FIG. 1A illustrates a schematic flow chart of a method 50 of forming the nanocomposite. The order in which the method 50 is described is not intended to be construed as a limitation, and any number of the described method steps can be combined in any order to implement the method 50. Additionally, individual steps may be removed or skipped from the method 50 without departing from the spirit and scope of the present disclosure.

At step 52, the method 50 includes heating a nanoparticle preparation mixture including an extract of Coleus amboinicus, nickel nitrate, and a hydroxide base to 250 to 350 °C, preferably 275 to 325 °C, preferably 300 °C to form the nickel oxide nanoparticles.

In some embodiments, the extract of Coleus amboinicus is an aqueous extract of Coleus amboinicus. The nickel nitrate serves as the nickel precursor for NiO formation, although other nickel salts such as nickel sulfate, nickel chloride, etc., may be used as well. The hydroxide base may be useful for facilitating the formation of nickel hydroxide intermediates. In some embodiments, the molar ratio of nickel nitrate to hydroxide base of 1:1 to 5:1, preferably 1.5:1 to 4.5:1, preferably 2:1 to 4:1, preferably 2.5:1 to 3.5:1, preferably 3:1.

At step 54, the method 50 includes ultrasonically mixing the nickel oxide nanoparticles with the porous carbon-containing biochar and the titanium carbide nanosheets having alkylammonium ions disposed on a surface of the nanosheets to form a reaction mixture. As used herein, the term ‘ultrasonication’ refers to a process that uses high-frequency sound waves to agitate particles in a liquid, creating pressure changes that generate microscopic bubbles. When these bubbles collapse, they produce shear forces that help break apart particles, disperse substances, or enhance chemical reactions. Ultrasonic mixing generates high-energy cavitation, ensuring uniform dispersion of the NiO nanoparticles, porous carbon-containing biochar and the titanium carbide nanosheets in the reaction mixture. This step may be useful for assisting in achieving a homogenous precursor mixture for the final composite. In some embodiments, other modes of agitation known to those of ordinary skill in the art, for example, via stirring, swirling, or a combination thereof may be employed to form the resultant mixture.

At step 56, the method 50 includes calcining the reaction mixture at 350 to 450 °C, preferably 375 to 425 °C, more preferably 400 °C to form the nanocomposite. The calcination may be carried out by heating it to a high temperature under a restricted supply of ambient oxygen. This is performed to remove impurities or volatile substances and to incur thermal decomposition. Typically, the calcination is carried out in a furnace, preferably equipped with a temperature control system.

In some embodiments, the method of forming the nanocomposite further includes forming the porous carbon-containing biochar. FIG. 1B illustrates a schematic flow chart of a method 70 of forming the porous carbon-containing biochar. The order in which the method 70 is described is not intended to be construed as a limitation, and any number of the described method steps can be combined in any order to implement the method 70. Additionally, individual steps may be removed or skipped from the method 70 without departing from the spirit and scope of the present disclosure.

At step 72, the method 70 includes heating a biochar preparation mixture including water, Coleus amboinicus leaves and a hydroxide base to form a precursor. Coleus amboinicus leaves are a promising raw materials for producing activated carbon as its rich in organic content, including cellulose, hemicellulose, and lignin, which contribute to the biochar's carbon yield. Suitable examples of the hydroxide base include sodium hydroxide, potassium hydroxide, calcium hydroxide, magnesium hydroxide, lithium hydroxide, barium hydroxide, aluminum hydroxide. In an embodiment, the concentration of the hydroxide base is in the range of 2.5 to 10 M, preferably 4 to 8 M, and yet more preferably 6 M.

In some embodiments, prior to heating, the leaves of Coleus amboinicus are washed with water. This wash may be useful to remove any impurities. The water may be tap water, distilled water, bidistilled water, deionized water, deionized distilled water, reverse osmosis water, and/or some other water. After washing, the leaves are through dried preferably oven-dried at 40-90 °C, preferably 50 to 80 °C, preferably 60 °C for 1 to 3 hours (h), preferably 2 h. After drying, in some embodiments, the dried leaves of Coleus amboinicus may be crushed, ground or milled to obtain a powder. In general, such crushing, grinding, or milling may be performed using any suitable equipment or using any suitable technique, such as a mixer, a mortar and pestle, a ball mill, a grinder, or a combination of these.

In some embodiments, the biochar preparation mixture is formed by heating the Coleus amboinicus leaves and a hydroxide base in water at 50 to 100 °C, preferably 60 to 80 °C, preferably 70 °C for 1 to 10 hours, preferably 3 to 8 hours, preferably 5 hours. In some embodiments, the heating can be performed by using heating appliances such as ovens, microwaves, autoclaves, hot plates, heating mantles and tapes, oil baths, salt baths, sand baths, air baths, hot-tube furnaces, and hot-air guns. In some embodiments, the heating is caried out till all the water is evaporated.

At step 74, the method 70 includes pyrolyzing the precursor to form a Coleus amboinicus biochar. Pyrolyzing refers to the process of chemically decomposing organic materials by subjecting them to high temperatures in the absence or limited presence of oxygen. This thermal decomposition process breaks down complex molecules into simpler compounds, often producing gases, liquids, and solid residues such as carbon-rich materials (e.g., biochar).

In some embodiments, pyrolysis is carried out at a temperature range of 400 to 800 degrees Celsius (°C) under an inert gas. For example, the pyrolysis may be carried out at 400 °C, 425 °C, 450 °C, 475 °C, 500 °C, 525 °C, 550 °C, 575 °C, 600 °C, 625 °C, 650 °C, 675 °C, 700 °C, 725 °C, 750 °C, 775 °C, or 800 °C. In some embodiments, the inert gas may be nitrogen, helium, or argon.

In some embodiments, heating may be performed by placing the precursor into a furnace such as a tube furnace, for example, in a ceramic crucible (e.g., an alumina crucible) or other forms of containment, and heating to the temperatures described above. The furnace is preferably equipped with a temperature control system, which may provide a heating rate of up to 50 °C/min, preferably up to 40 °C/min, or preferably up to 30 °C/min, preferably up to 20 °C/min, preferably up to 10 °C/min.

At step 76, method 70 includes functionalizing the Coleus amboinicus biochar by heating the Coleus amboinicus biochar in an acid mixture including nitric acid and sulfuric acid to form a functionalized Coleus amboinicus amboinicus biochar including carboxylic acid groups. In some embodiments, the Coleus amboinicus biochar is functionalized by reflux process using nitric acid and sulfuric acid in a ratio of preferably 3:1 at 50 to 100 °C, preferably 60 to 80 °C, preferably 70°C for 1 to 10 hours, preferably 3 to 8 hours, preferably 5 hours. In some embodiments, the acid mixture may include any combination of perchloric acid, hydroiodic acid, hydrobromic acid, hydrochloric acid, sulfuric acid, p-toluenesulfonic acid, methanesulfonic acid.

The present disclosure also relates to a method of detecting the presence of a pesticide in a sample. FIG. 1C illustrates a schematic flow chart of method 90 of detecting the presence of a pesticide in a sample. The order in which the method 90 is described is not intended to be construed as a limitation, and any number of the described method steps can be combined in any order to implement the method 90. Additionally, individual steps may be removed or skipped from the method 90 without departing from the spirit and scope of the present disclosure.

At step 92, the method 90 includes immersing a working electrode including the nanocomposite, a reference electrode, and a counter electrode in an analyte including the sample. In some embodiments, the analyte includes 0.1 to 2.5 M KOH, preferably 0.5 to 1.5 M KOH, preferably 1 M KOH. The working electrode refers to the electrode in an electrochemical cell/device/sensor on which the electrochemical reaction of interest is occurring. In some embodiments, the working electrode includes the nanocomposite.

As used herein, the term ‘reference electrode’ refers to an electrode with a stable and well-known electrode potential. Examples of suitable reference electrodes that may be used include, but are not limited to, standard hydrogen electrode (SHE), silver/silver chloride (Ag/AgCl) electrode, calomel electrode (saturated calomel electrode, SCE), copper/copper sulfate electrode (Cu/CuSO₄), standard calomel electrode (SCE), and Luggin capillary. In some embodiments, the reference electrode is a silver/silver chloride (Ag/AgCl) electrode.

The counter-electrode refers to the electrode used in an electrochemical cell for voltammetric analysis or other reactions in which an electric current is expected to flow. An outer surface of the counter electrode may include an inert (or non-reactive), electrically conducting chemical substance, such as platinum, gold, or carbon. A counter electrode including carbon can include carbon in the form of graphite or glassy carbon. In some embodiments, the counter electrode may be a wire, a rod, a cylinder, a tube, a scroll, a sheet, a piece of foil, a woven mesh, a perforated sheet, or a brush. The counter electrode material should be sufficiently inert to withstand the chemical conditions in the electrolyte solution, such as acidic or basic pH values, without substantially degrading during the electrochemical reaction. In addition, the counter electrode should preferably not leach out any chemical substance that interferes with the electrochemical reaction or might lead to undesirable electrode contamination. In some embodiments, the counter electrode is a platinum rod.

In some embodiments, the reference electrode and the counter-electrode may be connected through electrical interconnects that allow for the passage of current between the electrodes when a potential is applied between them. In some embodiments, the reference electrode and the counter-electrode can have the same or different dimensions. In general, the reference electrode and the counter-electrode may be arranged as known to a person of ordinary skill in the art.

At step 94, the method 90 includes applying a voltage to the working electrode and counter electrode. Generally, the applied potential may be varied linearly (e.g., cyclic voltammetry) or held constant (e.g., amperometry). In some embodiments, the voltage has a value of −1.0 to +1.0 V. For example, −1.0, −0.95, −0.90, −0.85, −0.80, −0.75, −0.70, −0.65, −0.60, −0.55, −0.50, −0.45, −0.40, −0.35, −0.30, −0.25, −0.20, −0.15, −0.10, −0.05, 0.05, 0.10, 0.15, 0.20, 0.25, 0.30, 0.35, 0.40, 0.45, 0.50, 0.55, 0.60, 0.65, 0.70, 0.75, 0.80, 0.85, 0.90, 0.95, or 1.0 V may be applied.

At step 96, the method 90 includes measuring a current response to determine at least one selected from a cathodic peak voltage, an anodic peak voltage, and a steady-state current. In some embodiments, the cathodic peak voltage is the voltage at which reduction of pesticide molecules may occur. In some embodiments, the anodic peak voltage is the voltage at which oxidation of pesticide molecules may occur. In some embodiments, a steady-state current is a constant current observed when a reaction stabilizes, the magnitude of which may be proportional to the pesticide concentration.

At step 98, the method 90 includes determining the presence of the pesticide in the analyte based on at least one selected from the group consisting of the cathodic peak voltage, the anodic peak voltage, and the steady-state current. In some embodiments, the presence of a pesticide is determined by analyzing the characteristic peaks or current responses corresponding to the redox activity of pesticide molecules. In some embodiments, the determining includes comparing the characteristic peaks or current responses with standard calibration curves or literature data. In some embodiments, the pesticide is at least one selected from the group consisting of of glyphosate and captan.

At step 98, the method 90 includes determining a concentration of the pesticide in the analyte based on at least one selected from the group consisting of the cathodic peak voltage, the anodic peak voltage, and the steady-state current, wherein the concentration of the pesticide in the analyte is 0.1 to 25 nM. For example, the concentration of the pesticide may be 0.1 nM, 0.25 nM, 0.5 nM, 0.75 nM, 1.0 nM, 1.25 nM, 1.50 nM, 1.75 nM, 2.0 nM, 2.25 nM, 2.5 nM, 2.75 nM, 3.0 nM, 3.5 nM, 4.0 nM, 4.5 nM, 5.0 nM, 5.5 nM, 6.0 nM, 6.5 nM, 7.0 nM, 7.5 nM, 8.0 nM, 8.5 nM, 9.0 nM, 9.5 nM, 10 nM, 22 nM, 12 nM, 13 nM, 14 nM, 15 nM, 16 nM, 17 nM, 18 nM, 19 nM, 20 nM, 21 nM, 22 nM, 23 nM, 24 nM, or 25 nM.

The method of the present disclosure may be highly selective. In some embodiments, the method shows a pesticide response that is 100 to 250% of a response to a non-pesticide. In some embodiments, the non-pesticide is at least one selected from the group consisting of urea, ammonium nitrate, and calcium nitrate.

### EXAMPLES

The following examples demonstrate a nanocomposite and method of preparation and pesticide detection in a sample thereof. The examples are provided solely for illustration and are not to be construed as limitations of the present disclosure, as many variations thereof are possible without departing from the spirit and scope of the present disclosure.

### Example 1: Biosynthesis of Nickel Oxide (NiO) Nanoparticles (NPs)

The preparation of NiO NPs was carried out using Mexican mint leaf extract as a fuel, employing the green solution combustion method. The reagent mixture was prepared by thoroughly mixing approximately 1 millilitre (mL) of Mexican mint leaf extract (Reagent-A) with 1 millimolar (mM) sodium hydroxide (NaOH) (Reagent-B). Further, in a muffle furnace, 1 g of [Ni(NO₃)₂·6H₂O] (Reagent-C) and 2 mL of the combination of Reagent-A and Reagent-B were placed and heated at 300 °C±10 °C for 2 hours. Furthermore, upon boiling, a transparent gel was formed, and the container subsequently filled with white foam as it expanded. The reaction mixture of reagents A, B, and C continued to burn, resulting in the formation of a white porous powder of NiO nanoparticles (NPs) as the final product.

### Example 2: Synthesis of Activated Biochar

The Mexican mint leaves were collected, thoroughly washed, and dried under sunlight, followed by oven drying at 60 °C for 2 hours. The dried leaves were then finely ground into powder and dispersed in 6 molar (M) potassium hydroxide to form a solution. The obtained mixture was refluxed at 70 °C for 5 hours, followed by pyrolysis to obtain biochar. The resultant biochar was treated with hydrochloric acid to remove any unreacted potassium hydroxide. Subsequently, the biochar was functionally modified through a reflux process using a mixture of nitric acid and sulphuric acid in a ratio of 3:1 at 70 °C for 5 hours to obtain functional biochar.

### Example 3: Synthesis of NiO-BC-MXene Nanocomposite

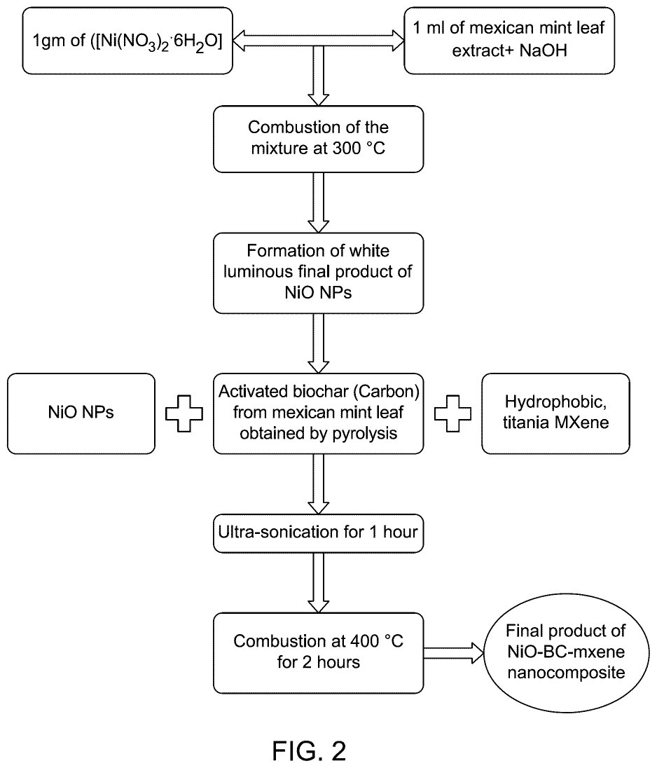

In a reaction container, NiO NPs, carbon powder, which is an activated biochar obtained by pyrolysis of Mexican mint leaves, and hydrophobic titania MXene (procured commercially from Sigma-Aldrich) were added in the ratio of 1:1:0.25, respectively. The combination of Mexican mint leaves and hydrophobic Titania MXene was thoroughly mixed by adding 5 mL of distilled water. Further, the mixture was subjected to ultra-sonication for proper dissociation of mixture. The sonication process was done employing a high-grade titanium alloy ultrasonic probe 13-millimetre (mm) diameter, powered by a 20 kilohertz (kHz) microprocessor unit (Model PRO-500, 500 W). High-quality dispersion was achieved through a high-power dissipation of 100 watts (W) and a 20% amplitude, ensuring effective dispersion of the powders. The subsequent product was then heated to 400 °C±10 °C in a furnace, treated with ethanol and deionized (DI) water to remove impurities, and filtered to obtain the final product, which is NiO-BC-MXene nanocomposite. The synthesis procedure for the formation of NiO-BC-MXene, as shown in FIG. 2.

### Example 4: Fabrication of a Sensor

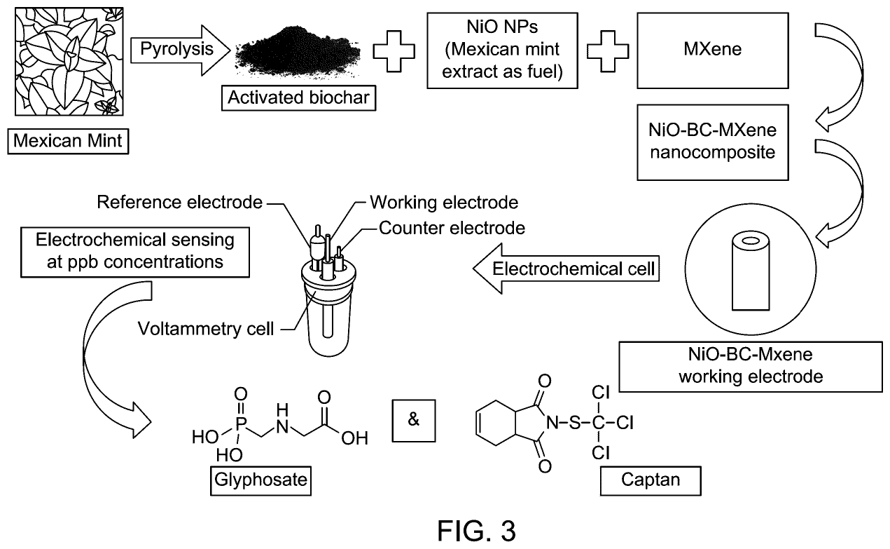

The NiO-BC-MXene nanocomposite powder, as obtained above, was thoroughly ground in an agate mortar for approximately 30 minutes. A slurry was prepared by mixing the NiO-BC-MXene nanocomposite powder, graphite powder, and silicone oil in a ratio of 15:70:15. The resulting slurry was then deposited onto a Teflon-coated disc, and the surface was smoothened to fabricate a working disc electrode. The electrode was subsequently dried at 60 °C in a vacuum oven, and electrical contacts were affixed for use in sensor examinations. The fabrication process of the sensor is shown in FIG. 3.

### Example 5: Characterization of the Nanocomposite

The synthesized materials were characterized, including surface morphology, particle size, and distribution analysis through scanning electron microscopy (SEM) and high-resolution transmission electron microscopy (HRTEM). Elemental mapping was performed using energy dispersive X-ray analysis (EDAX), structural features were examined via X-ray diffraction (XRD), and chemical bonding was analysed using Fourier transform infrared spectroscopy (FTIR).

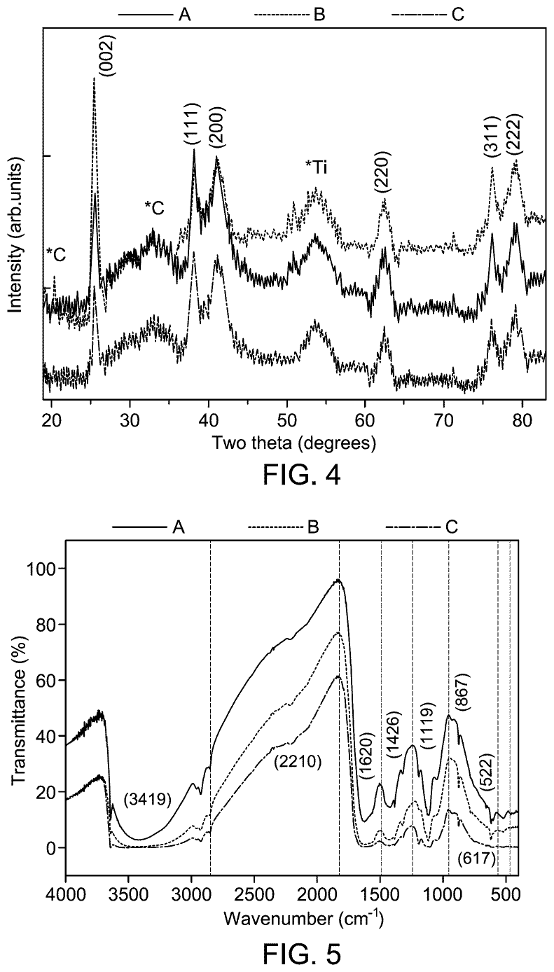

Powder X-ray diffraction (PXRD) patterns of the synthesized A, B, and C nanocomposites, are shown in FIG. 4. Each of the three samples exhibited a similar and pure cubic structure, with no peak's indicative of impurities, confirming the successful synthesis of the nanocomposites. The characteristic of NiO peaks were observed at (002), (111), (200), (222), (220), (311), and (222) crystal planes. All reflections were attributed to the face-centered cubic (fcc) NiO phase, which belongs to the space group 3 m and has a lattice constant (a) of 4.175 Å. The characteristic observed in the PXRD were identified based on the JCPDS (No. 47-1049) according to the PXRD data. The average crystallite size (D) was estimated from Scherrer's equation D=Kλ/βcos θ and was found to be in the range of 25 nm to 30 nm. The characteristic peak corresponding to activated biochar (*C) were observed at 2Θ=20° and 33°, whereas characteristic peak corresponding to Titanium of (Mxene) (*Ti) was observed at 2Θ=54°. The PXRD results confirms the formation of nanocomposite structure containing NiO, Carbon and Mxene.

Fourier transform Infrared (FT-IR) spectra of A, B, and C nanocomposites is shown in FIG. 5. A narrow and strong characteristic band at 3634 cm⁻¹ corresponding to (OH) stretching vibration, which is characteristic of NiO—C composite. The intense and wide band at 3419 cm⁻¹ was attributed to the O—H stretching vibration of the water molecules in the interlayer and the OH group was bonded to hydrogen. The peak at 1624 cm⁻¹ was due to the bending vibration of water molecules. The sharp peaks at 1426 cm⁻¹, 1119 cm⁻¹, and 867 cm⁻¹ were attributed to the O—C═O symmetric and asymmetric stretching vibrations, respectively. The C—O stretching vibration is expected to originate from the adsorption of atmospheric CO₂ or ethanol, but the band's intensity has diminished, suggesting that the ultrafine particles were physically absorbing H₂O and CO₂ relatively strongly. The NiO nanocomposites' FT-IR spectra revealed a prominent band at 522 cm⁻¹, which is attributed to the vibration of the Ni—O bond, following calcination. The broad absorption band at 3419 cm⁻¹, resulting from O—H stretching vibrations, suggested the physical absorption of water by the calcined particles. Additionally, the band at 617 cm⁻¹ corresponded to the characteristic deformation vibration of the Ti—O bond in Mxene.

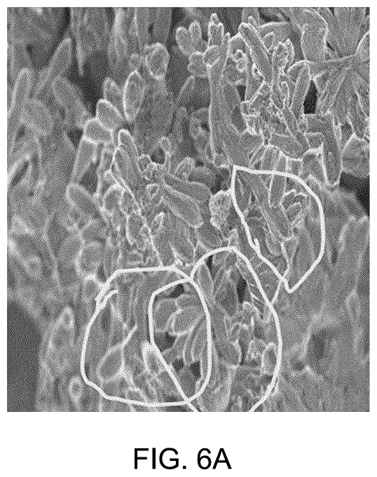

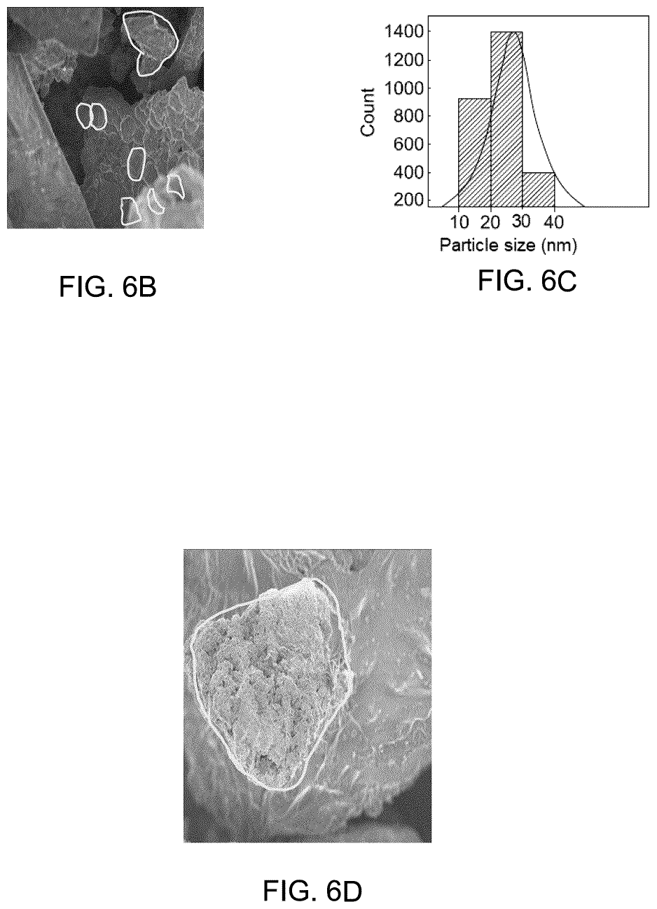

Morphological features of the A, B, and C nanocomposites were investigated by SEM, as shown in FIGS. 6A-6D. For composite A, the particle morphology exhibited a flower-petal-like structure with a smooth surface. In contrast, composite B displayed particles with a diamond structure in various shapes. The particle size, determined using Image J software, was found to be approximately ~25 nm, as shown in the histogram depicted in FIG. 6C. For composite C, the morphology transitioned to small and flat flakes. These variations in morphology were attributed to changes in the concentration of NiO and Carbon.

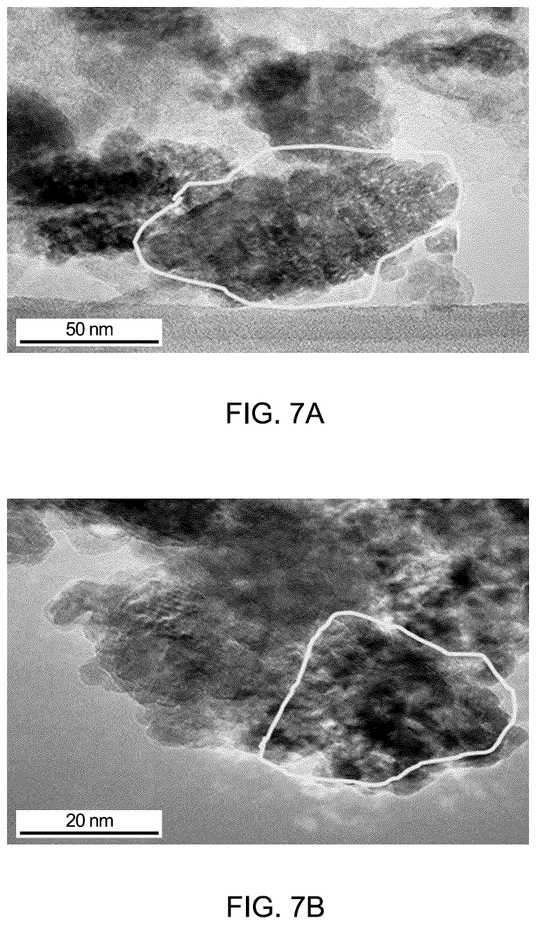

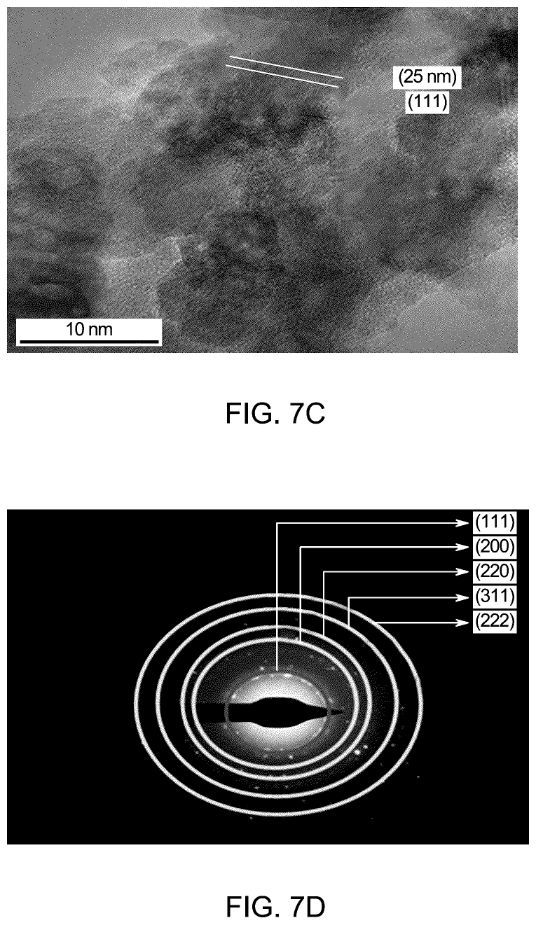

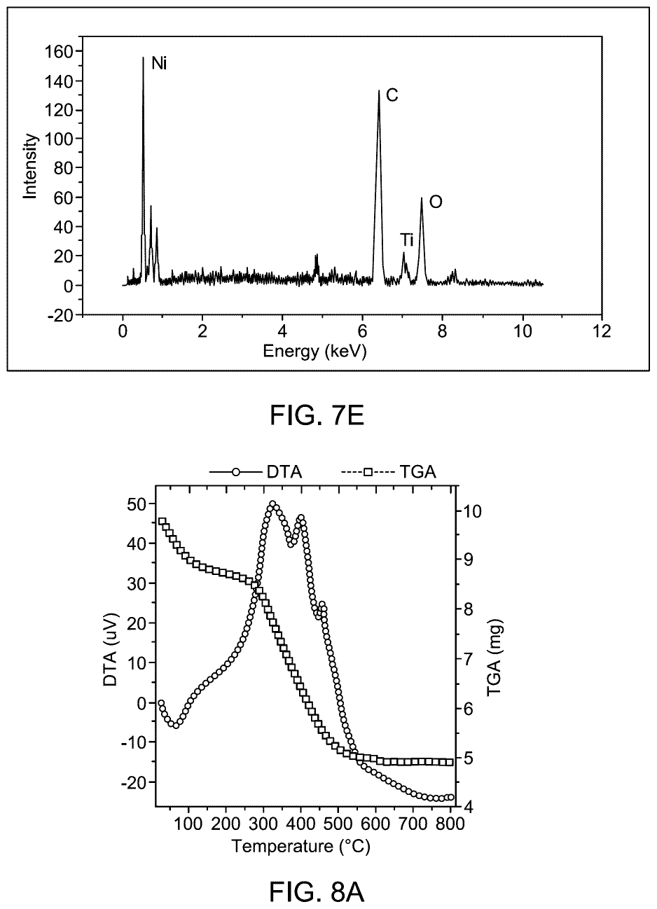

The transmission electron micrographs of NiO-Carbon-Mxene nanocomposite (Sample-C) are shown in FIGS. 7A-7C. The particles exhibited an average size in the range of 20 nm to 25 nm and were nearly spherical in shape, as observed. A HRTEM pattern revealed that a pure NiO nanocomposite had formed, with clearly defined lattice fringes. As shown in FIG. 7C, the estimated value for the NiO-Carbon-Mxene nanocomposites [d (111)=25 nm] closely matched the 25 nm gap between the neighboring lattice fringes of the nanoparticles. The selected area electron diffraction (SAED) pattern, further demonstrated the formation of the polycrystalline nature of the NiO-Carbon-Mxene nanocomposite, as shown in FIG. 7D. The EDAX spectra, revealed the presence of Ni, C, O, and Ti peaks without any impurities, confirming the formation of a pure NiO-Carbon-Mxene nanocomposite, as shown in FIG. 7E.

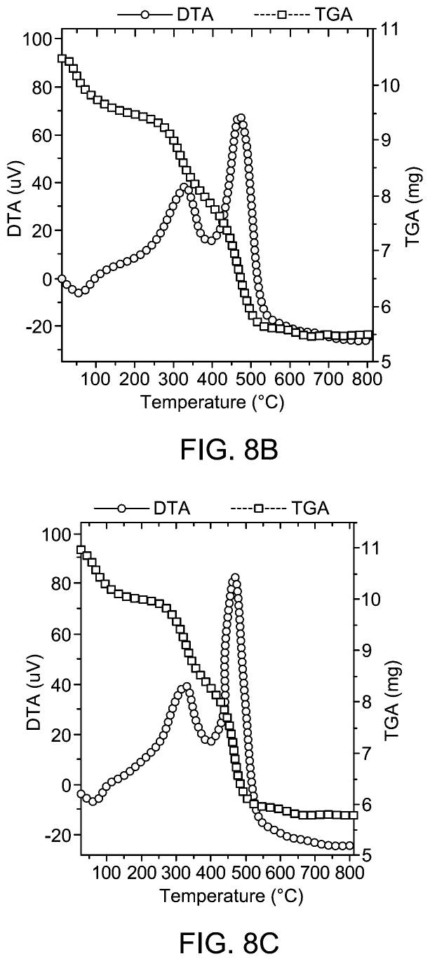

To further assess the thermal stability of the synthesized nanocomposites, TGA/DTA analysis was performed. The thermograms of the prepared nanocomposites shown thermal transition of the NiO-Carbon-Mxene nanocomposite when heated under oxygen from 0 °C to 800 °C are shown in FIGS. 8A-8C. The TGA-DTA curves indicated that the NiO-Carbon-Mxene nanocomposite decomposes in two stages, with weight loss happening between 50 °C and 280 °C and between 350 °C and 500 °C. As expected, the evaporation of water from the NiO-Carbon-Mxene nanocomposite resulted in a weight loss of approximately 8% in the first temperature range. In the second stage, the breakdown of encapsulated biomolecules associated with the activated biochar led to a 29% weight reduction. Along with the first mass loss observed in the TGA curve, a broad endothermic DTA peak spanning the 300 °C region was observed. A strong exothermic DTA peak around 500 °C corresponded to the second weight loss observed between 180 °C and 500 °C in the TGA curve. The thermal stability confirmed that the NiO-Carbon-Mxene nanocomposite remained stable above 570 °C, as no significant weight loss was observed beyond 500 °C. Furthermore, the carbon content in the NiO-Carbon-Mxene nanocomposite played a crucial role in its thermal stability, as evidenced by composite-C, with higher carbon content, demonstrating slightly better thermal stability compared to composites-A and B.

### Example 6: Sensor Performance Evaluation

Sensor evaluations were carried out to examine the electrochemical detection capabilities of the nanocomposite for glyphosate and captan at nanomolar (nM) concentrations. These studies assessed sensing responses across varying concentrations, response and recovery times, and long-term sensor stability. Additionally, multiple composite formulations were prepared, including Composite A (NiO:Carbon:Mxene in 1:1:0.2 ratio), Composite B (NiO:Carbon:Mxene in 1:2:0.2 ratio), and Composite C (NiO:Carbon:Mxene in 2:1:0.2 ratio), to enhance sensor performance.

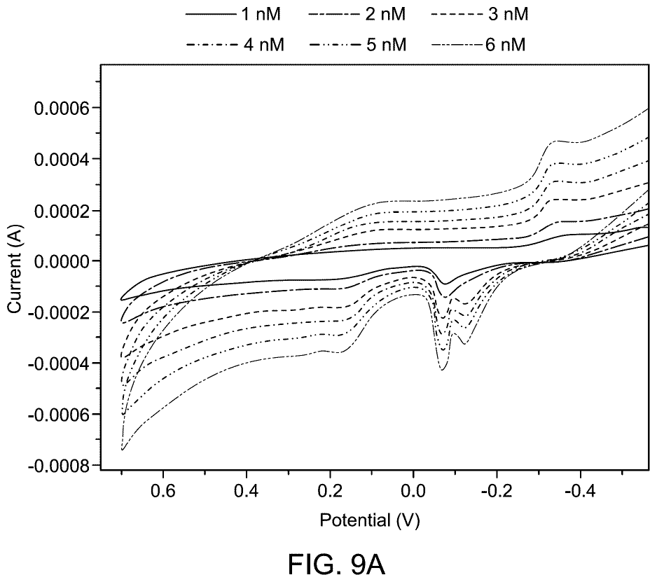

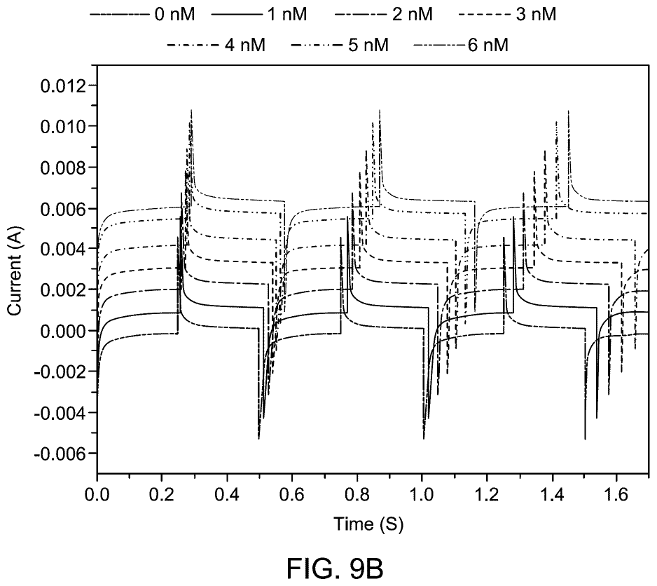

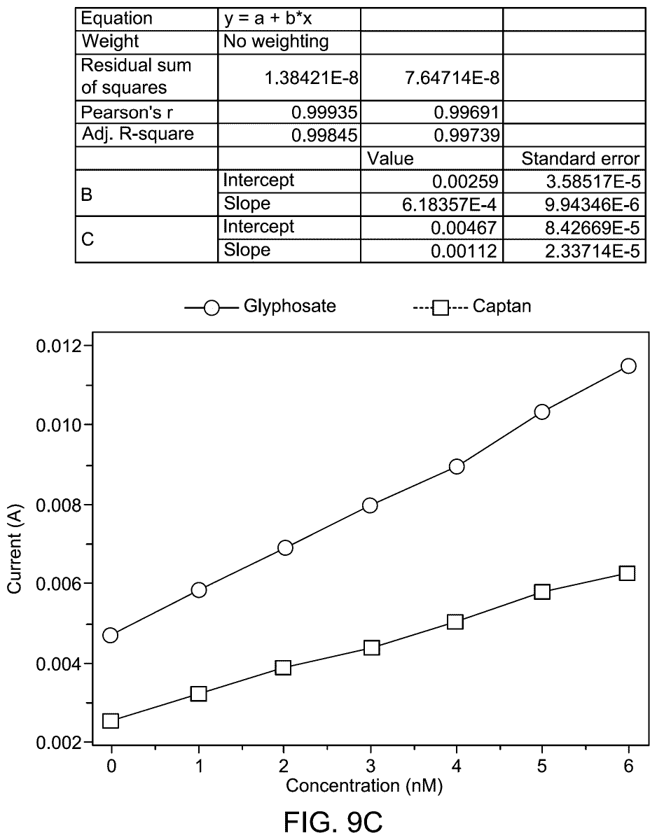

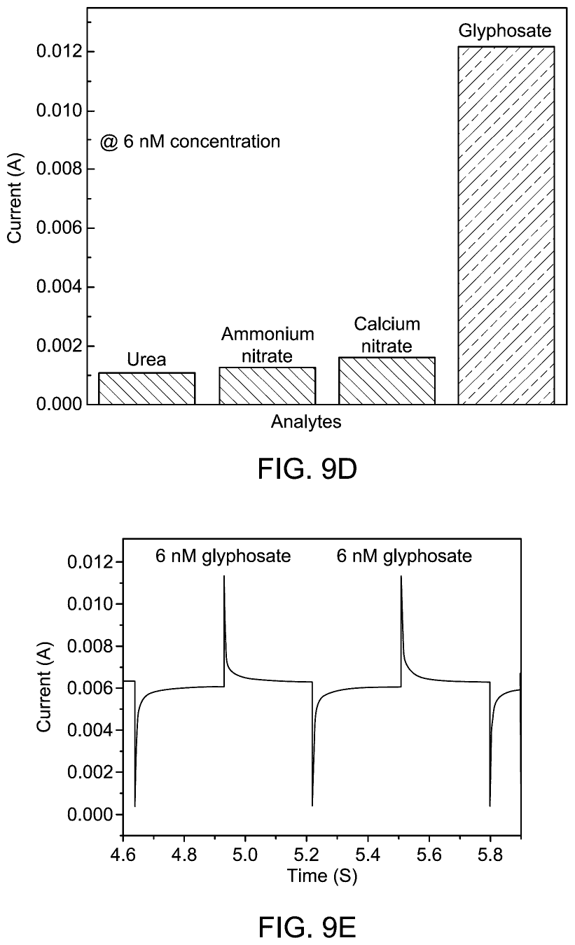

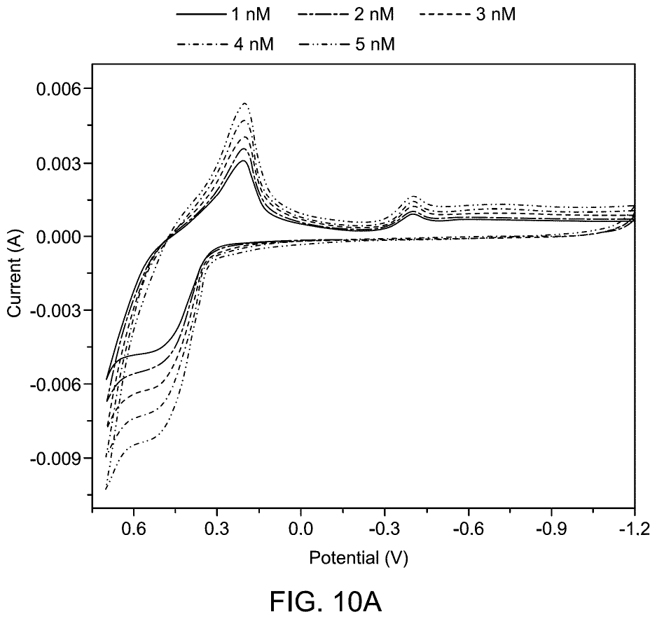

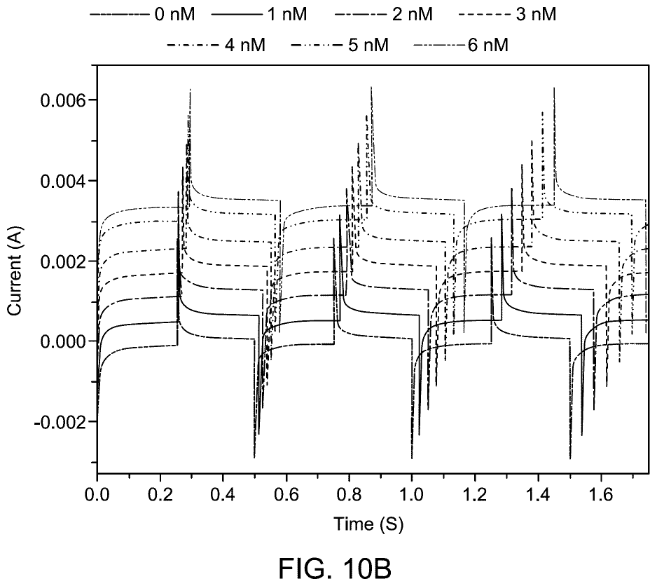

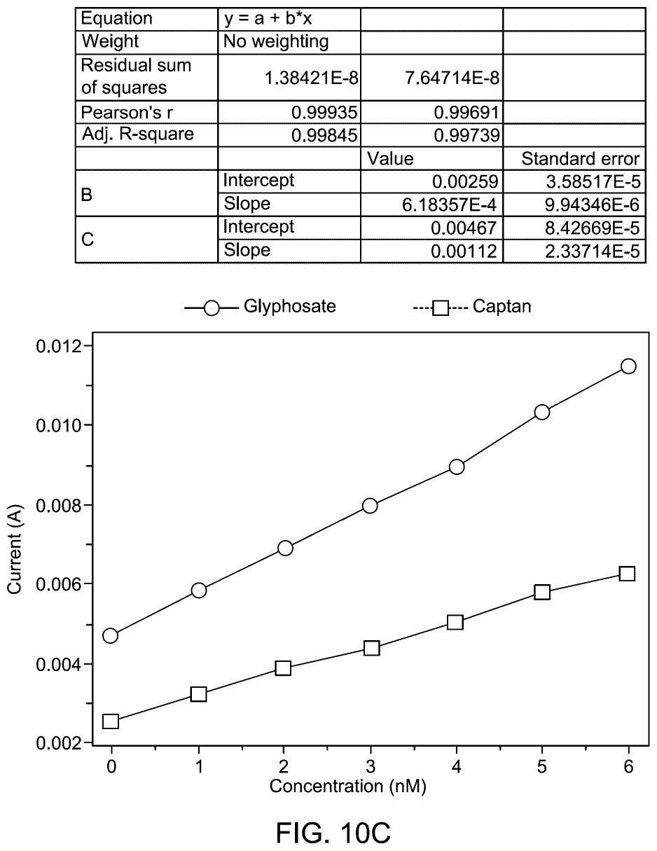

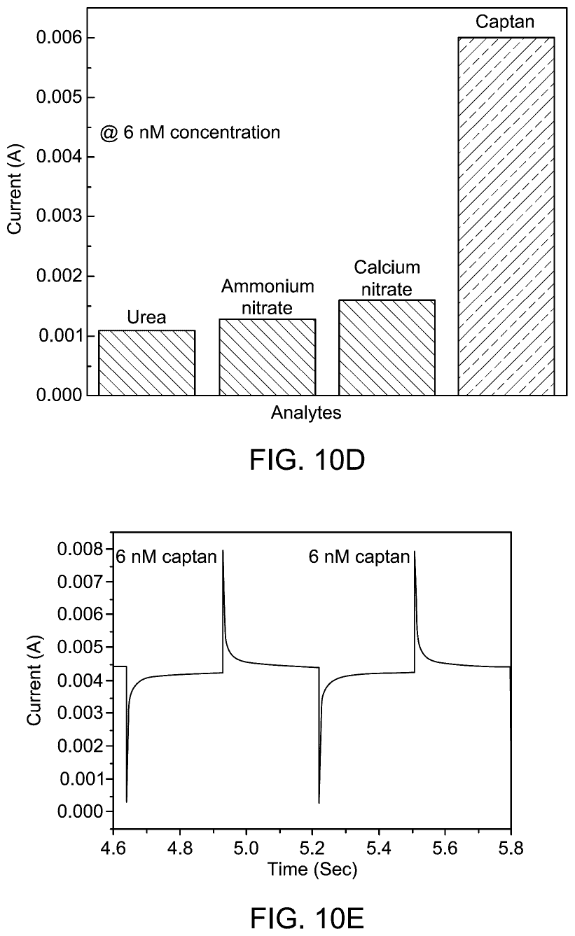

The sensor incorporating the NiO-Carbon-Mxene nanocomposite was fabricated as described in the fabrication section, as shown in FIG. 2. The modified glassy carbon electrode, prepared using the NiO-Carbon-Mxene nanocomposite with the highest carbon composition, was employed for the detection of hazardous pesticides, specifically ‘glyphosate’ and ‘captan’ at low concentrations (nM concentrations). A three-electrode system was used in the electrochemical workstation, with platinum as the counter electrode, Ag/AgCl as the reference electrode, and the NiO-Carbon-Mxene nanocomposite as the working electrode in 1 M KOH electrolyte. The modified NiO-Carbon-Mxene nanocomposite working electrode exhibited excellent response for the detection of both glyphosate and captan at low concentrations. Both analytes (glyphosate and captan) displayed pronounced cyclic voltammetry (CV) curves with varying concentrations, as shown in FIGS. 9A and 10A. The electrode demonstrated an excellent amperometric response, as shown in FIGS. 9E and 10E. The detection of glyphosate and captan, when compared to the control electrolyte, as shown in FIGS. 9B and 10B, with a distinct response that varied with the analyte concentrations. Furthermore, the electrode showed a linear response to varying concentrations, as shown in FIG. 9C, which is a critical feature of the sensing material employed in the conducted examination. The fabricated electrode was tested for selectivity against different molecules, demonstrating excellent selectivity for both glyphosate and captan, as shown in FIGS. 9D and 10D.

A NiO-Carbon-Mxene nanocomposite-based electrode was utilized as an efficient sensor for the electrochemical detection of glyphosate and captan at low concentrations (nM levels). The nanocomposite material utilized in the present disclosure demonstrates its potential as an efficient, multifunctional electrode for the detection of hazardous pesticides, paving the way for the development of low-cost, eco-friendly, and highly sensitive materials for the detection of glyphosate and captan.

Numerous modifications and variations of the present disclosure are possible in light of the above teachings. It is, therefore, to be understood that within the scope of the appended claims, the invention may be practiced otherwise than as specifically described herein.

1. A nanocomposite, comprising
30 to 65 wt. % titanium carbide nanosheets having alkylammonium ions disposed on a surface of the nanosheets;
30 to 65 wt. % nickel oxide nanoparticles; and
2 to 15 wt. % of a porous carbon-containing biochar, each based on a total weight of nanocomposite.

2. The nanocomposite of claim 1, wherein the alkylammonium ions are primary alkylammoinium ions having 6 to 20 carbon atoms.

3. The nanocomposite of claim 1, wherein the titanium carbide nanosheets having alkylammonium ions disposed on a surface of the nanosheets have a carbon content of 10 to 70 wt. %, based on a total weight of titanium carbide nanosheets having alkylammonium ions disposed on a surface of the nanosheets.

4. The nanocomposite of claim 1, wherein the titanium carbide nanosheets are nanosheets of a Ti₃C₂ MXene.

5. The nanocomposite of claim 1, wherein the nickel oxide nanoparticles are NiO nanoparticles.

6. The nanocomposite of claim 1, wherein the porous carbon-containing biochar is a Coleus amboinicus biochar.

7. The nanocomposite of claim 6, wherein the Coleus amboinicus biochar is a functionalized Coleus amboinicus biochar comprising carboxylic acid functional groups.

8. The nanocomposite of claim 1, which is in the form of particles having
a mean particle size of 5 to 50 nm, and
a particle shape which is at least one selected from a flower petal-like shape, a rhombus shape, and an irregular flake shape.

9. A method of forming the nanocomposite of claim 1, the method comprising
heating a nanoparticle preparation mixture comprising an extract of Coleus amboinicus, nickel nitrate, and a hydroxide base to 250 °C to 350 °C to form the nickel oxide nanoparticles;
ultrasonically mixing the nickel oxide nanoparticles with the porous carbon-containing biochar and the titanium carbide nanosheets having alkylammonium ions disposed on a surface of the nanosheets to form a reaction mixture; and
calcining the reaction mixture at 350 °C to 450 °C to form the nanocomposite.

10. The method of claim 9, wherein the extract of Coleus amboinicus is an aqueous extract of Coleus amboinicus.

11. The method of claim 9, wherein the nanoparticle preparation mixture has a molar ratio of nickel nitrate to hydroxide base of 1:1 to 5:1.

12. The method of claim 9, further comprising forming the porous carbon-containing biochar by
heating a biochar preparation mixture comprising water, Coleus amboinicus leaves and a hydroxide base to form a precursor;
pyrolyzing the precursor to form a Coleus amboinicus biochar.

13. The method of claim 12, wherein the biochar preparation mixture has a concentration of hydroxide base of 2.5 to 10 M.

14. The method of claim 12, wherein the biochar preparation mixture is formed by heating the Coleus amboinicus leaves and a hydroxide base in water at 50 to 100 °C for 1 to 10 hours.

15. The method of claim 12, further comprising functionalizing the Coleus amboinicus biochar by
heating the Coleus amboinicus biochar in an acid mixture comprising nitric acid and sulfuric acid to form a functionalized Coleus amboinicus biochar comprising carboxylic acid groups.

16. A method of detecting the presence of a pesticide in a sample, the method comprising
immersing a working electrode comprising the nanocomposite of claim 1, a reference electrode, and a counter electrode in an analyte comprising the sample;
applying a voltage to the working electrode and counter electrode;
measuring a current response to determine at least one selected from a cathodic peak voltage, an anodic peak voltage, and a steady-state current; and
determining the presence of the pesticide in the analyte based on at least one selected from the group consisting of the cathodic peak voltage, the anodic peak voltage, and the steady-state current.

17. The method of claim 16, wherein the analyte comprises 0.1 to 2.5 M KOH.

18. The method of claim 16, wherein the pesticide is at least one selected from the group consisting of glyphosate and captan.

19. The method of claim 16, further comprising determining a concentration of the pesticide in the analyte based on at least one selected from the group consisting of the cathodic peak voltage, the anodic peak voltage, and the steady-state current, wherein the concentration of the pesticide in the analyte is 0.1 to 25 nM.

20. The method of claim 16, wherein the method shows a pesticide response that is 100 to 250% of a response to a non-pesticide selected from the group consisting of urea, ammonium nitrate, and calcium nitrate.
